(19) United States
(12) Patent Application Publication
(10) Pub. No.: US 2015/0308272 A1
(43) Pub. Date: Oct. 29, 2015

(54) ROTARY PISTON ENGINE, IN PARTICULAR WITH ROTARY PISTONS CIRCULATING ABOUT THE IGNITION CHAMBER

(71) Applicant: Glenn ROLUS BORGWARD, Munich (DE)

(72) Inventor: Glenn ROLUS BORGWARD, Munich (DE)

(73) Assignees: RB HOLDING GMBH, Oldenburg (DE); BRANDS & PRODUCTS IPR-HOLDING GMBH & CO. KG, Munich (DE)

(21) Appl. No.: 14/236,808

(22) PCT Filed: Aug. 2, 2012
(86) PCT No.: PCT/EP2012/065158

§ 371 Date: May 14, 2014

(30) Foreign Application Priority Data
Aug. 2, 2011 (DE) 10 2011 109 966.6

(51) Int. Cl. F01C 1/12; F02B 53/12; F01C 21/18; F01C 1/18; F01C 1/20

(52) U.S. Cl. CPC F01C 1/123; F01C 1/18; F01C 1/20; F01C 21/18; F02B 53/12

(57) ABSTRACT

A rotary piston engine, comprising at least two working chambers formed by a housing, a working rotary piston rotating therein and at least one rotating auxiliary rotary piston. A method of operating the rotary piston engine. In order to allow different compression ratios and ignition timings and in order to increase the rotatability and leakproofness of the rotary pistons even during long-term operation of the rotary piston engine of the type in question, the rotary piston engine comprises at least two working chambers, which are formed by a housing, a working rotary piston rotating therein and at least one rotating auxiliary rotary piston, wherein a working gas can be transferred via at least one duct from at least one of the working chambers into at least one other of the working chambers.

The invention relates to a rotary piston engine, comprising at least two working chambers which are formed by a housing, a working rotary piston rotating therein and at least one rotating auxiliary rotary piston. The invention also relates to a method of operating said rotary piston engine.

A rotary piston engine having this kind of structural design is known from DE 39 06 081 A1. In this rotary piston engine a working gas is introduced through the rotating working rotary piston into one of the working chambers and compressed in this working chamber, and ignited and expanded before the burnt working gas is discharged, again through the working rotary piston.

It turned out that, e.g. in different speed ranges of the rotary piston engine, different compression ratios and ignition timings may be desirable. In the case of the known rotary piston engine this cannot be accomplished due to the fact that compression, expansion and ignition is fixedly coupled to the rotary movement of the working and auxiliary rotary pistons. In addition, the rotatability and the leakproofness of the rotary pistons may be impaired by combustion residues in the working chambers in the case of long-term operation.

It is therefore the object of the present invention to improve a rotary piston engine of the type in question, and a method of operating the same, such that different compression ratios and ignition timings will be possible and to increase the rotatability and the leakproofness of the rotary pistons even during long-term operation of the rotary piston engine.

The object of the present invention is achieved by the rotary piston engine according to claim 1, comprising at least two working chambers which are formed by a housing, a working rotary piston rotating therein and at least one rotating auxiliary rotary piston, wherein a working gas can be transferred via at least one duct from at least one of the working chambers into at least one other of the working chambers. Especially the ignition timing and the compression ratios can thus be controlled much better than in the case of a conventional rotary piston engine. In addition, the rotatability and the leakproofness of the rotary pistons can be improved even during long-term operation of the rotary piston engine, since ignition of the working gas can be accomplished outside the working chambers, so that less combustion residues are to be expected in the working chambers. As a result, a higher efficiency can be achieved by the rotary piston engine according to the present invention. The rotary piston engine according to the present invention can be operated with all commonly used fuels, in particular with petrol, diesel or hydrogen, and is particularly suitable for operating vehicles of all kinds, in particular aircraft, watercraft and ground vehicles as well as generators, compressors, combined heat and power plants or machine tools. An air-fuel mixture and the combustion products resulting therefrom are normally referred to as working gas.

Advantageous further developments of the invention are the subject matters of the subclaims.

It may be of advantage when the housing fulfills at least one of the following requirements:
The housing comprises at least one inlet for introducing a working gas in at least one of the working chambers.
The housing comprises at least one outlet for discharging a working gas from at least one of the working chambers.
The housing is configured such that, in a plane extending perpendicular to the axis of the working rotary piston, it has, on the outer side thereof, a curvature about the axis of the working rotary piston and/or a curvature about the axis of at least one of the auxiliary rotary pistons, the curvature having preferably an arc length of at least 45°, preferred at least 90°, particularly preferred at least 120°.
The housing is mirror symmetric, at least sectionwise, preferably mirror symmetric with respect to a plane defined by the axes of the working rotary piston and of the at least one auxiliary rotary piston.
The housing comprises at least two parts, preferably at least two substantially mirror-symmetric parts, preferred at least two identical parts, for covering the working rotary piston and the at least one auxiliary rotary piston on different sides of their circumference.
The housing is divided substantially in a plane defined by the axes of the working rotary piston and of the at least one auxiliary rotary piston, or in a plane which is parallel to the first-mentioned one.
The housing surrounds a synchronization mechanism for synchronizing the working rotary piston and the at least one auxiliary rotary piston.

A rotary piston engine according to at least one of these structural designs is compact and easy to mount. In case of a defect or retrofitting, individual components of the rotary piston engine, in particular the working rotary piston and the auxiliary rotary piston, can be exchanged easily.

It may prove to be helpful, when the working rotary piston fulfills at least one of the following requirements:
The working rotary piston delimits at least one of the working chambers in an axial direction at least on one side, preferably on both sides.
The working rotary piston delimits at least one of the working chambers in a circumferential direction at least on one side, preferably on both sides.
The working rotary piston delimits at least one of the working chambers in a radial direction at least on one side, preferably radially on the inner side.
The working rotary piston is broader than at least one of the auxiliary rotary pistons.
The working rotary piston overlaps at least one of the auxiliary rotary pistons in an axial direction at least on one side, preferably on both sides.
The working rotary piston is configured substantially as a hollow cylinder.
The compressed working gas is, for the purpose of ignition, conducted through the working rotary piston, preferably axially and/or radially, preferred radially inwards through the working rotary piston.
The working rotary piston comprises a substantially cylindrical circumferential surface with at least one pocket-shaped recess for forming at least one duct portion and/or at least one ignition chamber, wherein preferably a radius of the circumferential surface decreases abruptly in the direction of circulation of the working rotary piston at the beginning of the recess and then increases again with a smaller gradient to the original value.
The working rotary piston comprises two side parts, which are spaced apart in an axial direction and which define therebetween at least one of the working chambers, at least one of the side parts being, preferably at least sectionwise, circular or annular in shape.
The working rotary piston comprises at least one separating section for separating at least two of the working chambers from one another, the separating section extending preferably in an axial and/or radial direction of the working rotary piston for preferably connecting two side parts of the working rotary piston.
The working rotary piston comprises at least one reception means for at least one gas passage unit.
The working rotary piston comprises a radially inner section and a radially outer section, which are interconnected on a side part of the working rotary piston, a reception means for a gas passage unit being provided on another side part of the working rotary piston between the radially inner section and the radially outer section, said reception means opening in an axial direction.
The working rotary piston defines or comprises at least one portion of the duct, which is adapted to be aligned with at least one other portion of the duct, preferably a portion of the duct which is fixed in position relative to the housing, such that the duct portions can communicate, the portion of the duct being preferably defined, at least sectionwise, by a circumferential surface and/or by a side part of the working rotary piston.
The working rotary piston defines or comprises at least one portion of the duct which extends through the working rotary piston, preferably in a radial direction, a portion of the duct being preferably slot-shaped and extending in the circumferential direction of the working rotary piston, preferably at least two identical duct portions being arranged side-by-side in an axial direction of the working rotary piston.
The working rotary piston comprises a cover, which has the shape of a section of the circumferential surface of a cylinder and which is preferably located subsequent to a separating bar end defining the leading end in the direction of rotation, so as to delimit, at least sectionwise, at least one of the working chambers in a radial direction on the inner side, the cover extending preferably over only part of the circumference of the working rotary piston so as to keep an opening free, which extends over at least part of the circumference of the working rotary piston so that the duct can communicate with at least one of the working chambers, preferably with at least one other of the working chambers, via the opening.
The working rotary piston is configured asymmetrically.
The working rotary piston comprises elements for stiffening and/or elements for controlling thermal expansion and/or elements for balancing, preferably ribs and/or materials with different thermal expansion characteristics and/or material openings, in particular balancing holes.
The working rotary piston has an eccentric center of gravity.
The working rotary piston is sealed off from the housing.
The working rotary piston comprises at least one seal, in particular a seal strip, which, preferably by means of a spring, is biased radially outwards for sealing a separating section of the working rotary piston off from the at least one auxiliary rotary piston, the seal being secured in position on the working rotary piston, preferably in a form-fit manner.

The rotary piston engine according to at least one of these structural designs can offer various advantages in comparison with a conventional rotary piston engine, in particular when the working chamber is laterally delimited by the working rotary piston. The shear forces created between the working gas and the housing will thus be smaller, since the contact area between the working gas and the housing will be minimized.

It may prove to be advantageous, when at least one of the rotating auxiliary rotary pistons fulfills at least one of the following requirements:
The auxiliary rotary piston is arranged in the housing.
The auxiliary rotary piston comprises a geometry complementary to that of the working rotary piston.
The auxiliary rotary piston sealingly rolls on the working rotary piston.
The auxiliary rotary piston divides a space between the working rotary piston and the housing into a working chamber with increasing volume and a working chamber with decreasing volume.
The auxiliary rotary piston cooperates with the working rotary piston such that the auxiliary rotary piston expels, preferably completely, a working gas from at least one of the working chambers.
The auxiliary rotary piston comprises at least one reception portion for receiving therein a separating section of the working rotary piston.
The auxiliary rotary piston is force-coupled to the working rotary piston, preferably via a gear mechanism, preferred via a toothed gear unit.
The auxiliary rotary piston is configured asymmetrically.
The auxiliary rotary piston comprises elements for stiffening and/or elements for controlling thermal expansion and/or elements for balancing, preferably ribs and/or materials with different thermal expansion characteristics and/or material openings, in particular balancing holes.
The auxiliary rotary piston has an eccentric center of gravity.
The auxiliary rotary piston is sealed off from the housing.
The auxiliary rotary piston rotates with a circumferential speed which is different from that of the working rotary piston.
The axes of the auxiliary rotary pistons and the axis of the working rotary piston are located in the same plane.

A rotary piston engine according to at least one of these structural designs facilitates filling and emptying of the working chambers in different operating phases of the rotary piston engine.

An advantageous embodiment of the invention relates to a rotary piston engine, wherein the duct fulfills at least one of the following requirements:
The duct is adapted to be closed.
The duct allows a flow of working gas in only one direction.
The duct is substantially gas-tight so that the working gas is conducted between an inlet-side and an outlet-side opening of the duct substantially without any pressure losses.
The duct can, on the inlet side and/or outlet side thereof, communicate with at least one of the working chambers only in a rotation angle range of the working rotary piston, preferably in a shiftable rotation angle range of the working rotary piston, wherein the rotation angle range of the working rotary piston, in which the duct communicates with at least one of the working chambers on its inlet side, is preferably different from a rotation angle range of the working rotary piston, in which the duct communicates with at least one other of the working chambers on its outlet side.
The duct can, on its inlet side, only open towards one of the working chambers and, on its outlet side, only open towards at least one other of the working chambers, so that a working gas can flow into the duct (4) only from at least one of the working chambers and flow out of the duct only into at least one other of the working chambers.
The duct reduces the length of a working gas path, a path through the duct between an inlet-side and an outlet-side opening of the duct being shorter than an arc length about the axis of the working rotary piston between the inlet-side and the outlet-side opening of the duct.
The duct comprises at least two duct portions, which are adapted to be aligned with one another so as to allow communication therebetween, at least one of the duct portions rotating within the housing and at least one other of the duct portions belonging to the housing or being fixed in position relative to the housing, wherein at least one of the rotating duct portions and at least one of the stationary duct portions are capable of communicating with one another in a rotation angle range of the working rotary piston, preferably in a shiftable rotation angle range of the working rotary piston, wherein at least one of the rotating duct portions is arranged radially within one of the stationary duct portions and/or at least one of the rotating duct portions is arranged radially outside of at least one of the stationary duct portions.
The duct comprises at least two groups of duct portions, wherein the duct portions of one group are adapted to be aligned with one another so as to allow communication therebetween, wherein at least one of the duct portions of a group rotates within the housing and at least one other of the duct portions of a group belongs to the housing or is fixed in position relative to the housing, wherein at least one of the rotating duct portions and at least one of the stationary duct portions of a group are capable of communicating with one another in a rotation angle range of the working rotary piston, preferably in a shiftable rotation angle range of the working rotary piston, wherein, in relation to the axis of the working rotary piston, the duct portions of different groups do not overlap one another preferably in an axial direction and/or not in a radial direction and/or not in a circumferential direction, wherein the duct portions of one group and the duct portions of another group are preferably capable of communicating with one another only in different rotation angle ranges of the working rotary piston, wherein at least one of the rotating duct portions of a group is arranged radially inside of at least one of the stationary duct portions of a group and/or at least one of the rotating duct portions of a group is arranged radially outside of at least one of the stationary duct portions of a group.
The duct opens on its inlet side and/or outlet side substantially tangentially to the circumference of the working rotary piston into at least one of the working chambers, an angle defined by an axis of the duct and the tangent on the circumference of the working rotary piston in the area of the opening being preferably not larger than 89°, preferred not larger than 45°, particularly preferred not larger than 30° and most preferred not larger than 15°, measured in or opposite to the direction of rotation of the working rotary piston.
The duct opens, on its inlet side and/or outlet side, in an axial and/or radial direction, preferably in a radial direction from inside, into at least one of the working chambers.
The duct branches, on its inlet side, off from a trailing end of at least one of the working chambers.
The duct opens, on its outlet side, into at least one of the working chambers at a leading end.
The duct extends, at least sectionwise, within the working rotary piston, preferably along and/or within a circumferential surface and/or along or within at least one side part of the working rotary piston.
A cross-section of the duct converges on the inlet side and/or diverges on the outlet side (when seen in direction of flow).
An outlet-side opening of the duct extends over at least 50%, preferably over at least 75%, preferred over 100% of the axial length and/or the circumferential length of the working chamber communicating therewith.
An inlet-side opening of the duct and an outlet-side opening of the duct do not overlap in an axial direction and/or not in a radial direction and/or not in a circumferential direction related to the axis of the working rotary piston.
An inlet-side opening of the duct and an outlet-side opening of the duct are spaced apart in an axial direction and/or in a radial direction and/or in a circumferential direction related to the axis of the working rotary piston.
An inlet-side opening of the duct and an outlet-side opening of the duct are different in size, the outlet-side opening of the duct being preferably larger, preferably larger by at least 50%, preferred by at least 100%, particularly preferred by at least 200%, than the inlet-side opening of the duct.
At least one second duct transfers a working gas from at least a further one of the working chambers into at least still a further of the working chambers.

A rotary piston engine according to at least one of these embodiments has the advantage that the duct can, according to requirements, be opened on only one side thereof for conducting the working gas in only one direction through the duct from the compression chamber into the expansion chamber. A flowback of the working gas can thus be excluded even in the case of very high speeds and pressures. If flushing of the duct is desirable, the duct may, at least temporarily, be opened on the inlet side as well as on the outlet side thereof, e.g. for a short period of time while conducting the working gas into or compressing it in the inlet-side working chamber.

It may be of advantage, when the rotary piston engine comprises at least one ignition chamber, which fulfills at least one of the following requirements:
The duct conducts a working gas through the ignition chamber, preferably exclusively through the ignition chamber.
The ignition chamber communicates with the duct.
The ignition chamber is arranged radially within and/or axially within the working rotary piston.
The ignition chamber is formed radially within and/or axially within the working rotary piston.
The ignition chamber is located, at least at the moment of ignition, at least partially between the axis of the working rotary piston and the axis of at least one of the auxiliary rotary pistons.
The ignition chamber overlaps at least one of the working chambers, preferably a working chamber communicating with the inlet-side opening of the duct, in a radial direction.
The ignition chamber can communicate via at least one opening with an injection device and/or an ignition device, the opening being preferably adapted to be closed, wherein preferably a plurality of ignition devices are arranged on different sides of the ignition chamber.
The ignition chamber comprises a cooling, preferably a water cooling, and/or an oil lubrication, preferably a forced feed lubrication.
The ignition chamber is configured as a recess or pocket of the working rotary piston.
The ignition chamber rotates together with the working rotary piston.
The working rotary piston rotates about the ignition chamber.
The ignition chamber is fixed in position relative to the housing, preferably adjustably fixed in position relative to the housing.
The ignition chamber comprises and/or defines a portion of the duct.
The ignition chamber is located on an outlet-side end of the duct.
The ignition chamber forms an outlet-side end of the duct.
The ignition chamber opens divergently towards at least one of the working chambers, preferably to a leading end of at least one of the working chambers.

In a rotary piston engine according to one of the above-mentioned embodiments, the position of the ignition chamber can be optimized such that the ignition chamber will be able to communicate via particularly short gas paths through the duct with an inlet-side and an outlet-side working chamber. Energy losses caused by re-routing or deflection of the working gas are thus minimized.

It may prove to be useful, when the rotary piston engine comprises at least one gas passage unit, which fulfills at least one of the following requirements:
The duct conducts a working gas through the gas passage unit, preferably exclusively through the gas passage unit.
The gas passage unit communicates with the duct.
The gas passage unit forms a part of the housing.
The gas passage unit is fixed in position on the housing from inside or from outside.
The gas passage unit is adjustably fixed on the housing.
The gas passage unit is mechanically adjustable or dynamically displaceable, preferably dynamically displaceable by an open-loop control or a closed-loop control.
The gas passage unit is adapted to be rotated relative to the housing in a circumferential direction.
The gas passage unit is arranged coaxially with the working rotary piston.
The gas passage unit is substantially hollow cylindrical.
The gas passage unit is arranged radially and/or axially within the working rotary piston.
The gas passage unit delimits at least one of the working chambers in a radial direction on at least one side, preferably on a radially inner side.
The gas passage unit delimits the ignition chamber in a radial direction on at least on one side, preferably on a radially outer side.
The gas passage unit comprises the ignition chamber.
The gas passage unit can preferably be sealingly installed in a reception means of the working rotary piston, preferably the gas passage unit and a radially outer section of the working rotary piston defining together, at least sectionwise, at least one of the working chambers and/or the gas passage unit and a radially inner section of the working rotary piston defining together, at least sectionwise, at least one ignition chamber.
The gas passage unit comprises at least one portion of the duct, which is adapted to be aligned with at least one other portion of the duct, preferably with a rotating duct portion, preferred with a duct portion of the working rotary piston, such that the duct portions can communicate, in particular in an axial and/or radial direction in relation to the axis of the working rotary piston.
The gas passage unit comprises at least two portions of the duct, which are each adapted to be alternately aligned with at least one other portion of the duct, preferably with a rotating duct portion, preferred with a duct portion of the working rotary piston, such that the duct portions can communicate, in particular in an axial and/or radial direction in relation to the axis of the working rotary piston.
The gas passage unit comprises at least two gas passage portions, which are displaceable relative to one another and which each comprise at least one portion of the duct, the gas passage portions being preferably displaceable while the portions of the duct communicate with one another, the gas passage portions being preferably rotatable relative to one another.
The gas passage unit comprises at least one post-compressor.
At least one of the duct portions of the gas passage unit is substantially slot-shaped and extends in a circumferential direction through a circumferential surface of the gas passage unit.

It may be proved to be useful, when at least one of the working chambers fulfills at least one of the following requirements:
At least one of the working chambers forms a compression chamber for compressing a working gas.
At least one of the working chambers forms an expansion chamber for expanding a working gas.
At least two of the working chambers have, in relation to a rotation axis of the working rotary piston, different axial and/or radial dimensions.
At least two of the working chambers have, in a plane including a rotation axis of the working rotary piston, different cross-sectional shapes.
In a plane including a rotation axis of the working rotary piston, a working chamber or a group of working chambers having the larger cross-sectional area forms a compression chamber or a group of compression chambers, and a working chamber or a group of working chambers having the smaller cross-sectional shape forms an expansion chamber or a group of expansion chambers.
At least two of the working chambers are displaced relative to one another in an axial direction and/or in a radial direction and/or in a circumferential direction.
At least two of the working chambers, preferably all the working chambers, are arranged in succession in a direction of circulation.
At least two of the working chambers are arranged in an overlapping mode of arrangement in an axial direction and/or in a radial direction and/or in a circumferential direction.
At least two of the working chambers are arranged in a non-overlapping mode of arrangement in an axial direction and/or in a radial direction and/or in a circumferential direction.
At least two of the working chambers are arranged, at least sectionwise, side-by-side in an axial direction.

According to an advantageous embodiment of the invention, the rotary piston engine comprises at least one post-compressor, which fulfills at least one of the following requirements:
The duct conducts a working gas through the post-compressor, preferably exclusively through the post-compressor, so that the working gas is compressed in the post-compressor.
The post-compressor communicates with the duct.
The post-compressor compresses a working gas after the latter has left at least one of the working chambers.
The post-compressor compresses the working gas before the latter is introduced in another one of the working chambers.
The post-compressor compresses the working gas mechanically and/or pneumatically and/or hydraulically.
The post-compressor expels the working gas preferably completely in the direction of an outlet-side working chamber.
The post-compressor supports the introduction of the working gas into an inlet-side working chamber by aspirating the working gas while the post-compressor communicates with the inlet-side working chamber via the duct.
The post-compressor causes self-ignition of the working gas through compression.
The post-compressor comprises a reciprocating piston compressor with at least one reciprocating piston and at least one compression chamber, wherein the reciprocating piston compressor forms two compression chambers preferably at opposed end of the reciprocating piston, wherein the reciprocating piston temporarily closes and temporarily opens preferably at least one inlet-side and/or at least one outlet-side opening of the compression chamber.
The post-compressor comprises at least one cam for moving preferably at least one reciprocating piston of a reciprocating piston compressor, wherein the cam is preferably mechanically coupled to the working rotary piston and/or arranged coaxially with the working rotary piston, wherein the cam rotates preferably with the same angular speed as the working rotary piston.
The post-compressor is arranged, at least sectionwise, radially within and/or axially within the working rotary piston.
The post-compressor forms, at least sectionwise, the ignition chamber.
The working gas is ignited within the post-compressor.

A further aspect of the invention relates to a method of operating a rotary piston engine, in particular the rotary piston engine according to at least one of the preceding embodiments, comprising at least two working chambers formed by a housing, a working rotary piston rotating therein and at least one rotating auxiliary rotary piston, wherein a working gas can be transferred via at least one duct from at least one of the working chambers into at least one other of the working chambers, the method comprising the following steps:
compressing a working gas in at least one of the working chambers;
introducing the compressed working gas into the duct; and
discharging the working gas for expansion into at least one other of the working chambers.

Further advantageous embodiments of the invention result from arbitrary combinations of the features disclosed.

### SHORT DESCRIPTION OF THE FIGURES

FIG. 1 shows a schematic side view of parts of a rotary piston engine according to a first variant of the first embodiment of the present invention in a first operating phase.

FIG. 2 shows a schematic front view of parts of the rotary piston engine according to FIG. 1 in the first operating phase.

FIG. 3 shows a schematic side view of parts of the rotary piston engine according to FIG. 1 in a second operating phase.

FIG. 4 shows a schematic rear view of parts of the rotary piston engine according to FIG. 1 in the second operating phase.

FIG. 5 shows a schematic exploded view of parts of the rotary piston engine according to FIG. 1.

FIG. 6 shows a schematic side view of parts of the rotary piston engine according to a second variant of the first embodiment of the present invention in a first operating phase.

FIG. 7 shows a schematic front view of parts of the rotary piston engine according to FIG. 6 in the first operating phase.

FIG. 8 shows a schematic side view of parts of the rotary piston engine according to FIG. 6 in a second operating phase.

FIG. 9 shows a schematic rear view of parts of the rotary piston engine according to FIG. 6 in the second operating phase.

FIG. 10 shows a perspective exploded view of parts of the rotary piston engine according to a third variant of the first embodiment of the present invention.

FIG. 11 shows a schematic side view of parts of the rotary piston engine according to FIG. 10 in an operating phase.

FIG. 12 shows a schematic front view of parts of the rotary piston engine according to FIG. 10 in an operating phase.

FIG. 13 shows a schematic rear view of parts of the rotary piston engine according to FIG. 10 in an operating phase.

FIG. 14 a-l show various schematic views of parts of the rotary piston engine according to a third variant of the first embodiment of the present invention in various operating phases and strokes of the rotary piston engine.

FIG. 15 a-c show various schematic views for illustrating the adjustability of the gas passage portion relative to the housing of the rotary piston engine according to the third variant of the first embodiment of the present invention.

FIG. 16 shows a perspective view of the rotary piston engine according to the third variant of the first embodiment of the present invention, the housing being shown in a fragmentary sectional view.

FIG. 17 a-d show various perspective views of parts of the rotary piston engine according to a first variant of the second embodiment of the present invention, which is based on the first variant of the first embodiment.

FIG. 18 a-f show various views of parts of the rotary piston engine according to a second variant of the second embodiment of the present invention, which is based on the second variant of the first embodiment.

FIG. 19 shows a perspective view of parts of the rotary piston engine according to a second variant of the third embodiment of the present invention, which is based on the third variant of the first embodiment.

FIG. 20 a-j show various views of parts of the rotary piston engine according to a fourth variant of the second embodiment of the present invention, which is based on the third variant of the first embodiment.

FIG. 21 a-e show various perspective views of parts of the rotary piston engine according to a fifth variant of the second embodiment of the present invention, which is based on the third variant of the first embodiment.

FIG. 22 a-b show various perspective views of parts of the rotary piston engine according to a sixth variant of the second embodiment of the present invention, which is based on the fourth and fifth variants of the second embodiment.

FIG. 23 a-c show various schematic sectional views through rotary piston engines with various embodiments of gas passage units.

### DETAILED DESCRIPTION OF THE PREFERRED EMBODIMENTS

In the following, the preferred embodiment of the present invention will described making reference to the figures.

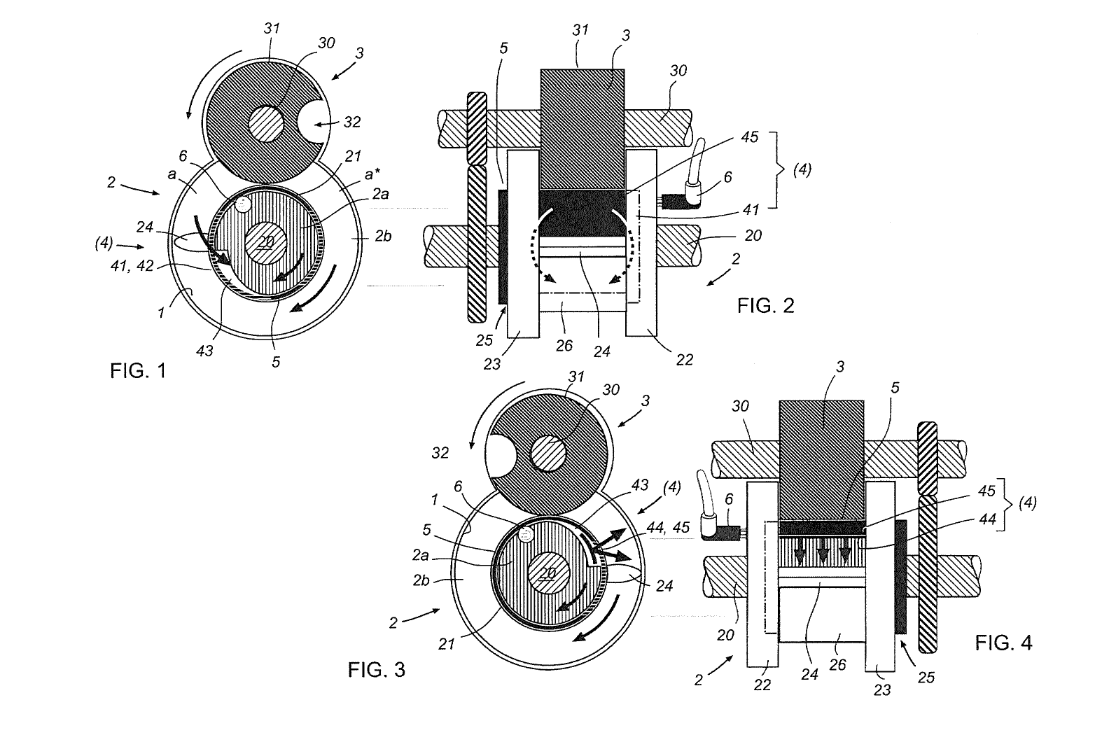

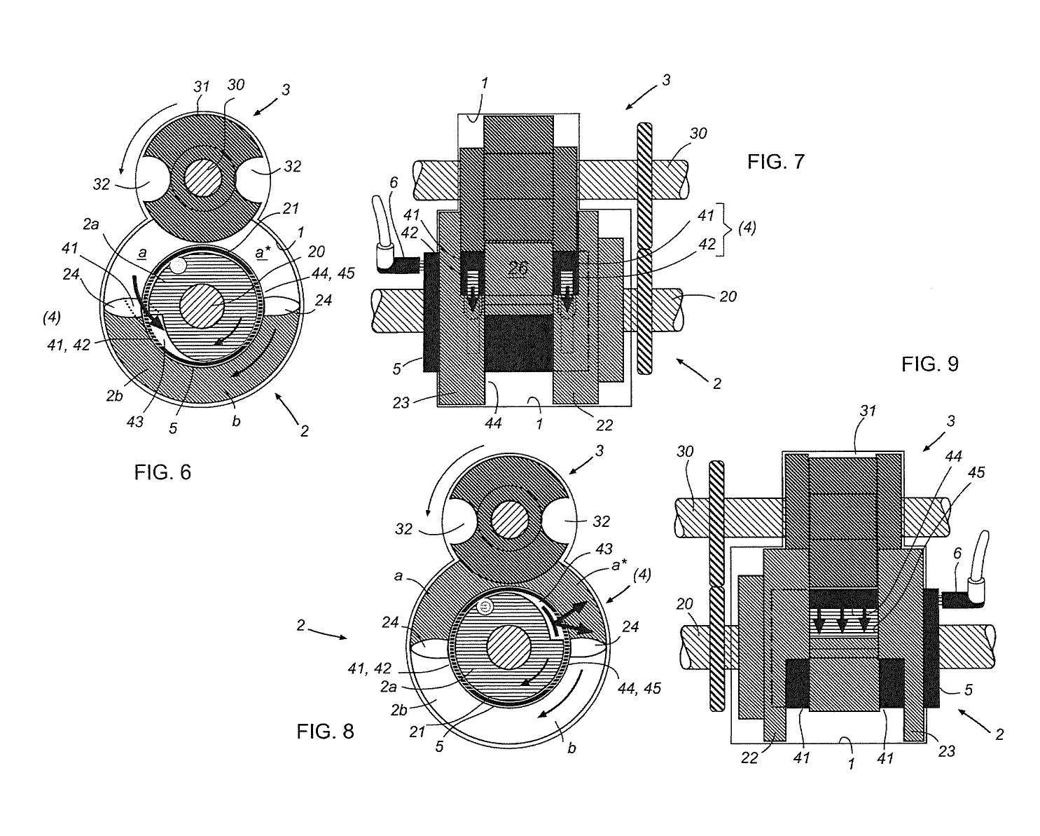

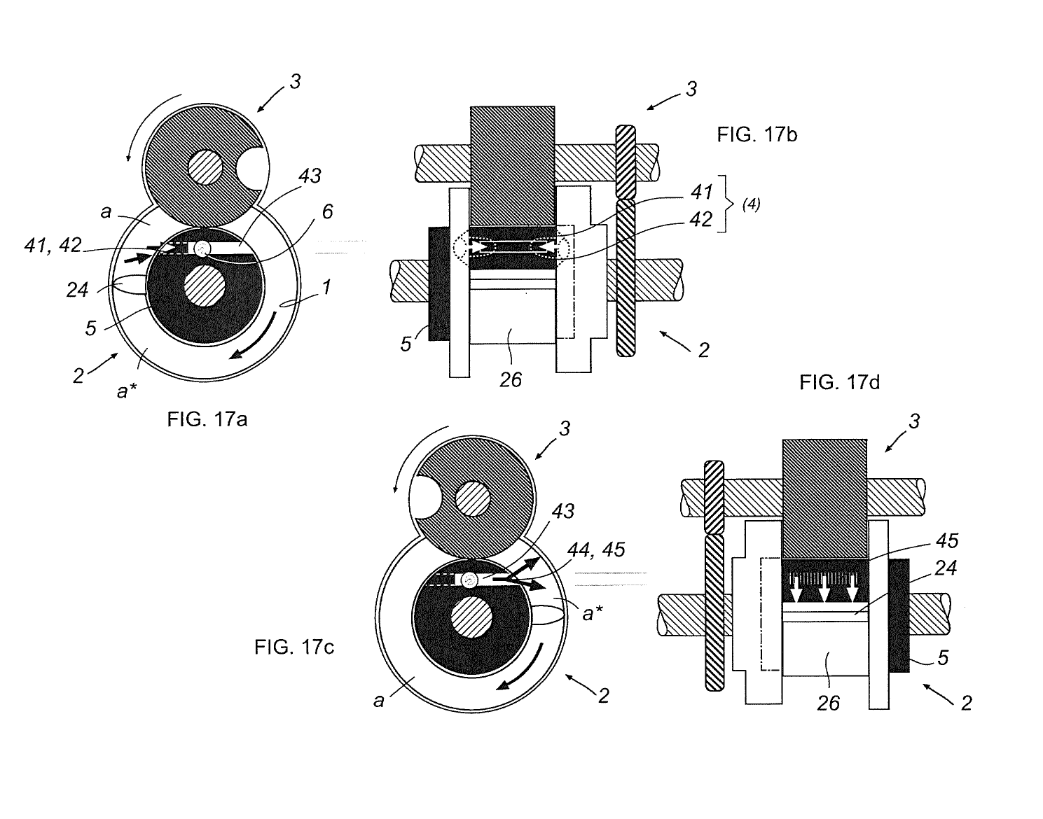

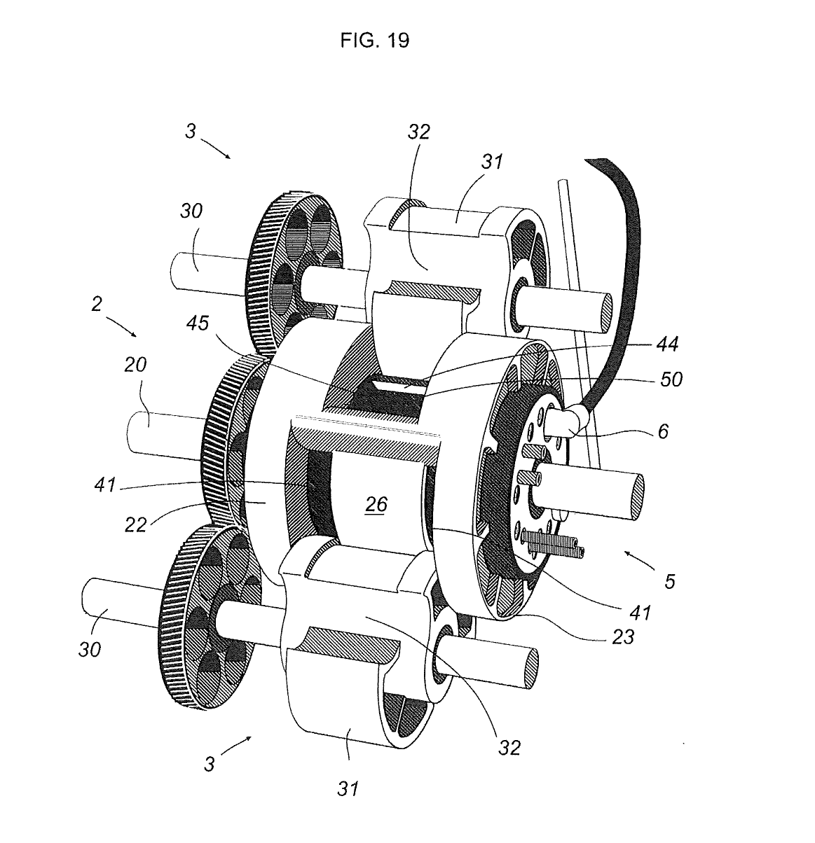

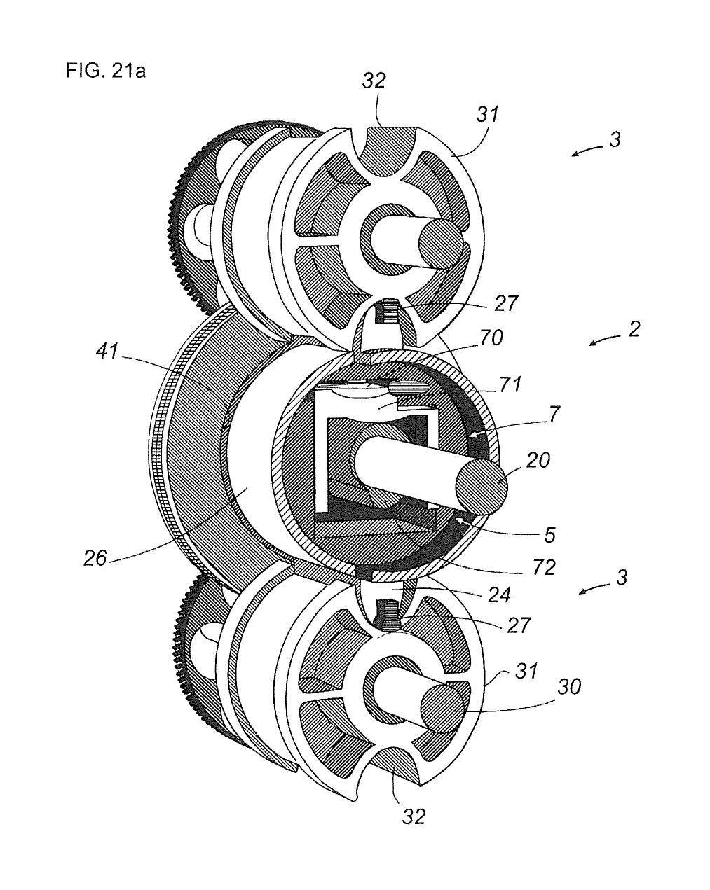

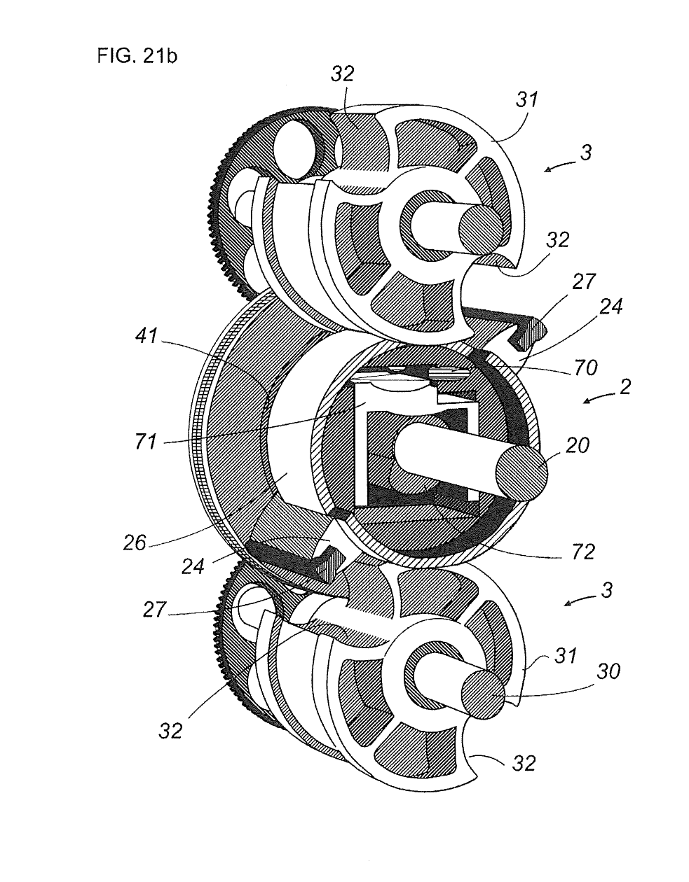

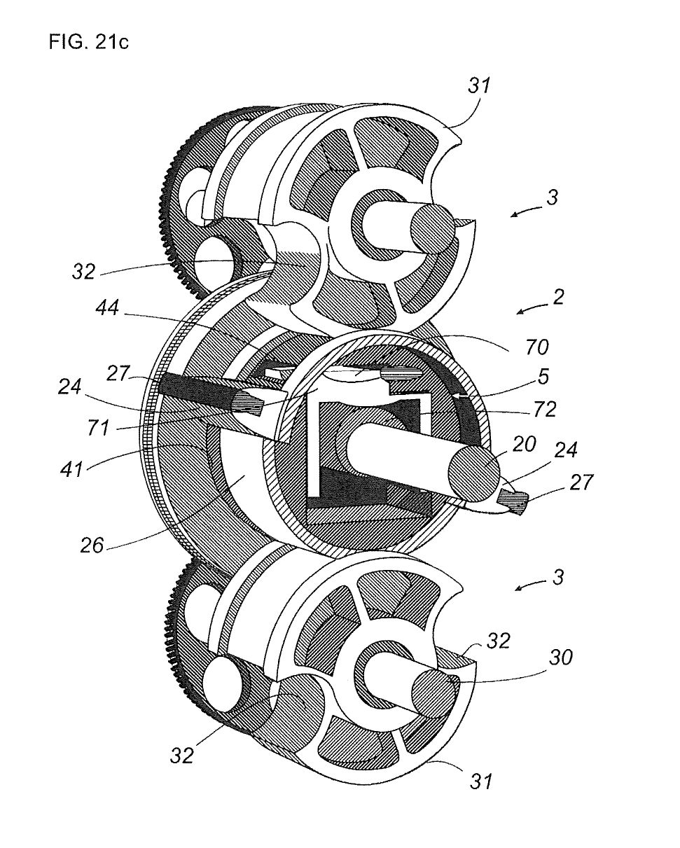

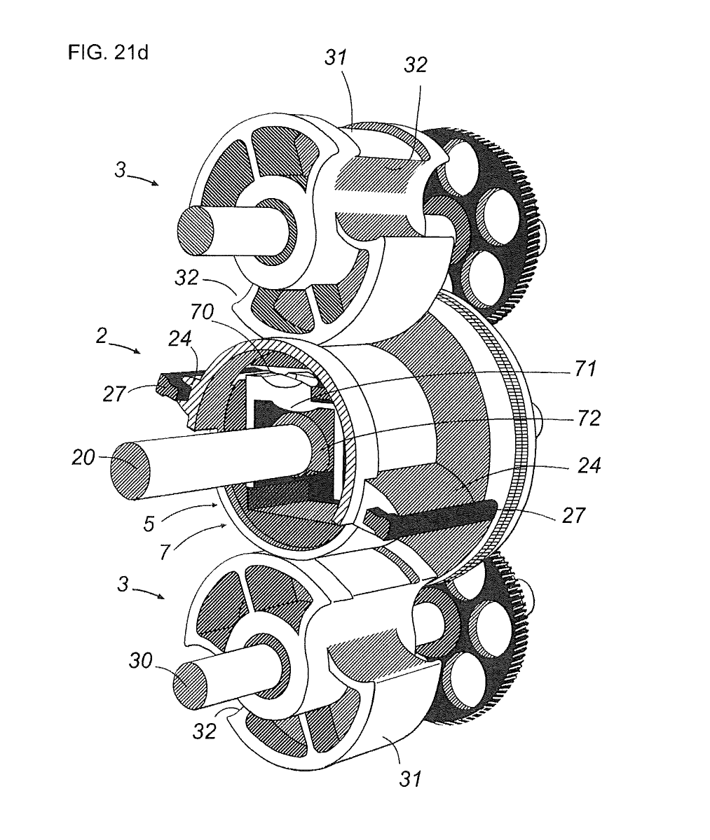

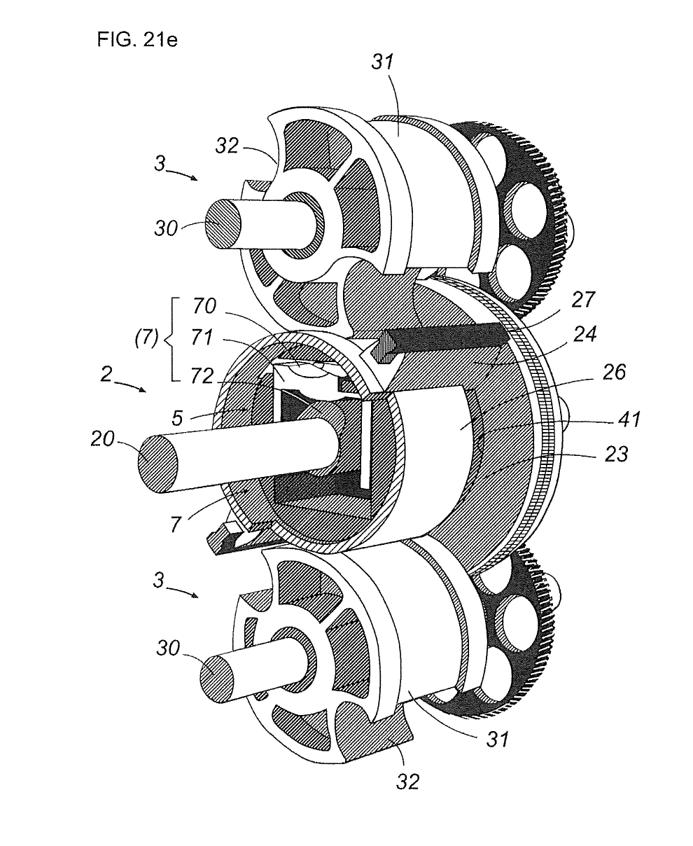

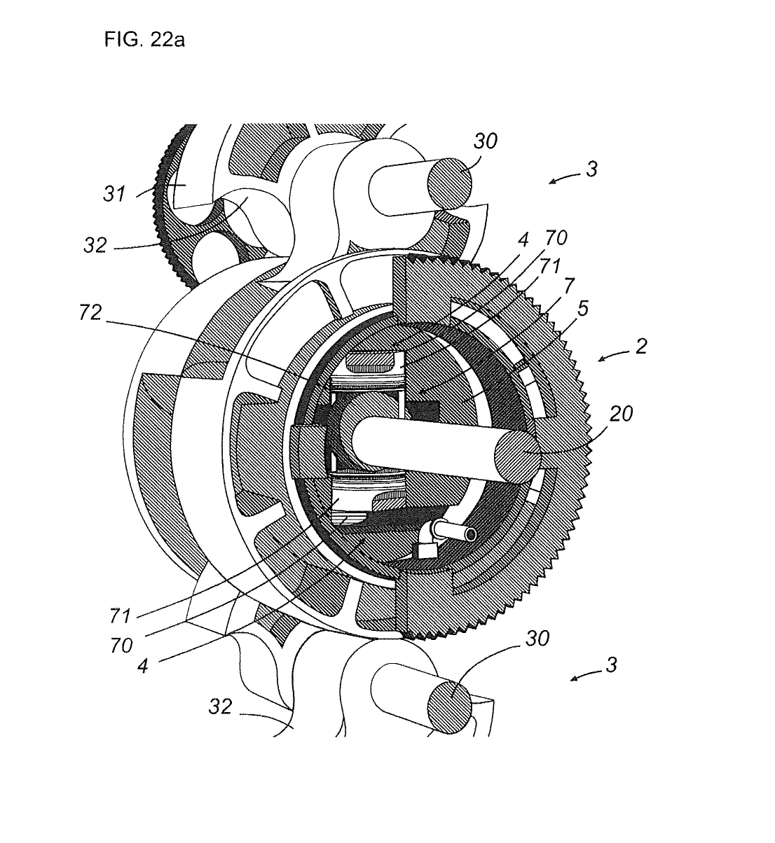

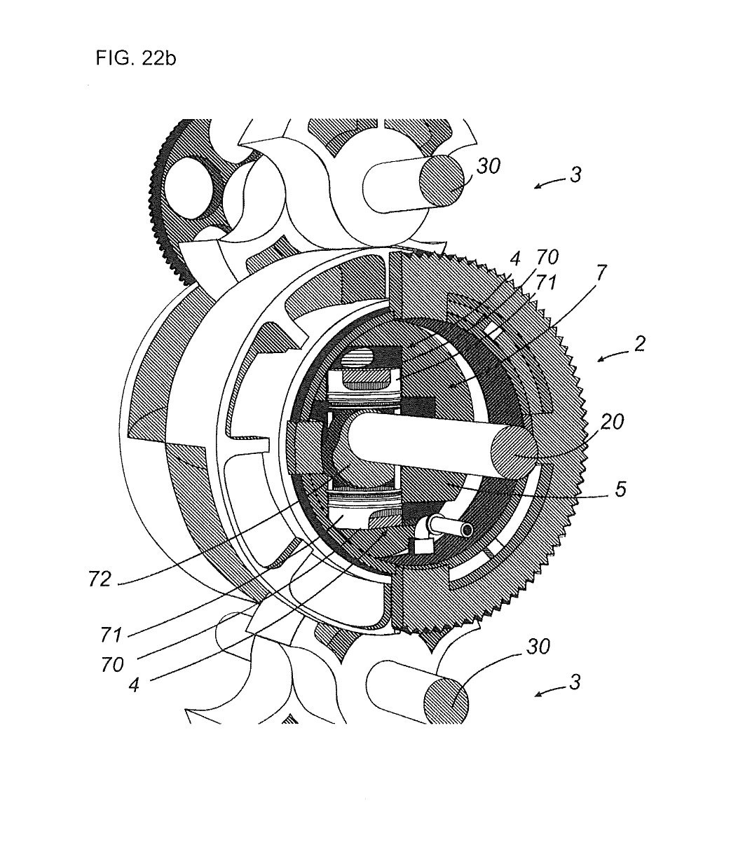

The first embodiment (FIGS. 1 to 16) relates to a rotary piston engine with a moving ignition chamber and the second embodiment (FIGS. 17 to 22) relates to a rotary piston engine with a stationary ignition chamber. As regards the first embodiment (FIGS. 1 to 16) three variants are described, the first variant (FIGS. 1 to 5) comprising an auxiliary rotary piston and two working chambers, the second variant (FIGS. 6 to 9) comprising an auxiliary rotary piston and three working chambers, and the third variant (FIGS. 10 to 16) comprising two auxiliary rotary pistons and four working chambers. As regards the second embodiment six variants are described. The first two variants (FIG. 17 a-d; 18 a-f) of the second embodiment (FIGS. 17 to 22) are essentially based on the first two variants of the first embodiment, and the third to sixth variants (FIGS. 19 to 22) are essentially based on the third variant of the first embodiment. In particular, the fourth (18 20 a-j) and the sixth variant (FIG. 22 a-b) of the second embodiment are configured such that the working chambers are displaced in a circumferential direction and in a radial direction relative to one another and do not overlap one another. In the fifth variant (FIG. 21 a-e) of the second embodiment, the rotary piston engine comprises a post-compressor with one compression chamber, and in the sixth variant (FIG. 22 a-b) it comprises a post-compressor with two compression chambers. The features of the individual variants can easily be interchanged.

### First Embodiment

The basic functional principle of the invention is illustrated making reference to the first embodiment. Identical reference numerals will be used for comparable features throughout the description. Instead of repeating the description, the same reference numerals are used in different figures. If the same reference numerals are used once more, the relevant differences existing in comparison with the preceding description will be discussed, where necessary.

The invention relates to a rotary piston engine comprising at least two working chambers a/a*, which are formed by a housing 1, a working rotary piston 2 rotating therein and at least one rotating auxiliary rotary piston 3, wherein a working gas can be transferred via at least one duct 4 from at least one of the working chambers a to at least one other of the working chambers a*.

The primary function of the housing 1 is to accommodate the working rotary piston 2 and the at least one rotating auxiliary rotary piston 3 so as to form the working chambers a/a* for compressing and expanding the working gas. The working gas is compressed in at least one of the working chambers a, ignited and expanded in at least one other of the working chambers a*. The expansion energy of the ignited working gas is used for driving the working rotary piston 2 according to the principle of a turbine. The driving power of the working rotary piston 2 can especially be tapped off from a working shaft 20 for driving e.g. a motor vehicle.

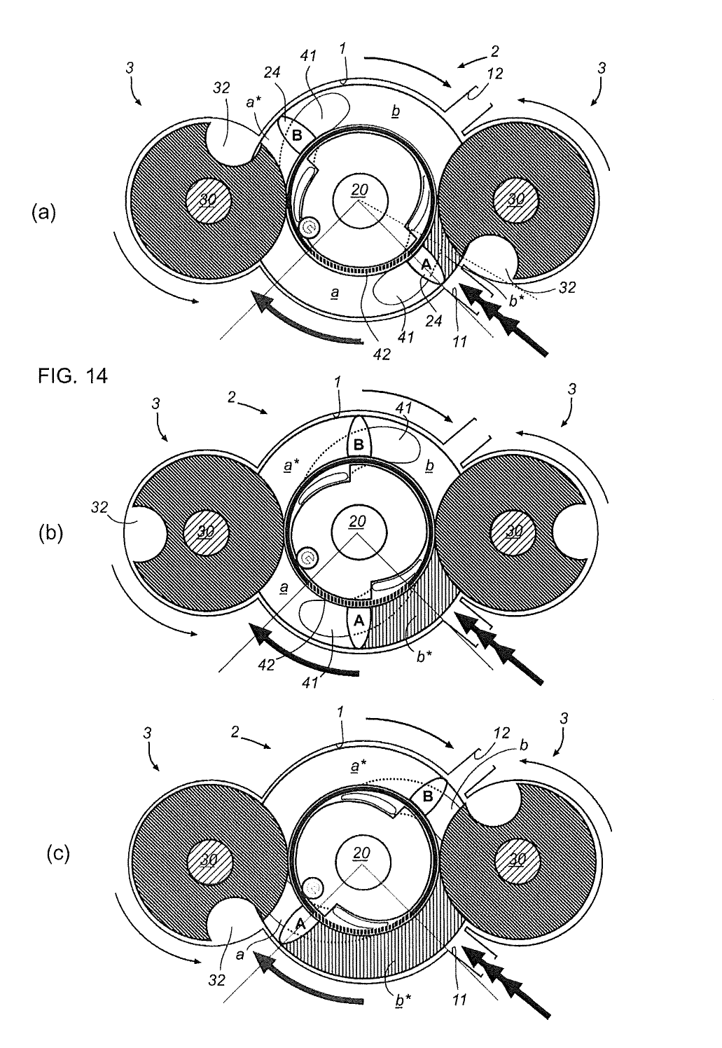

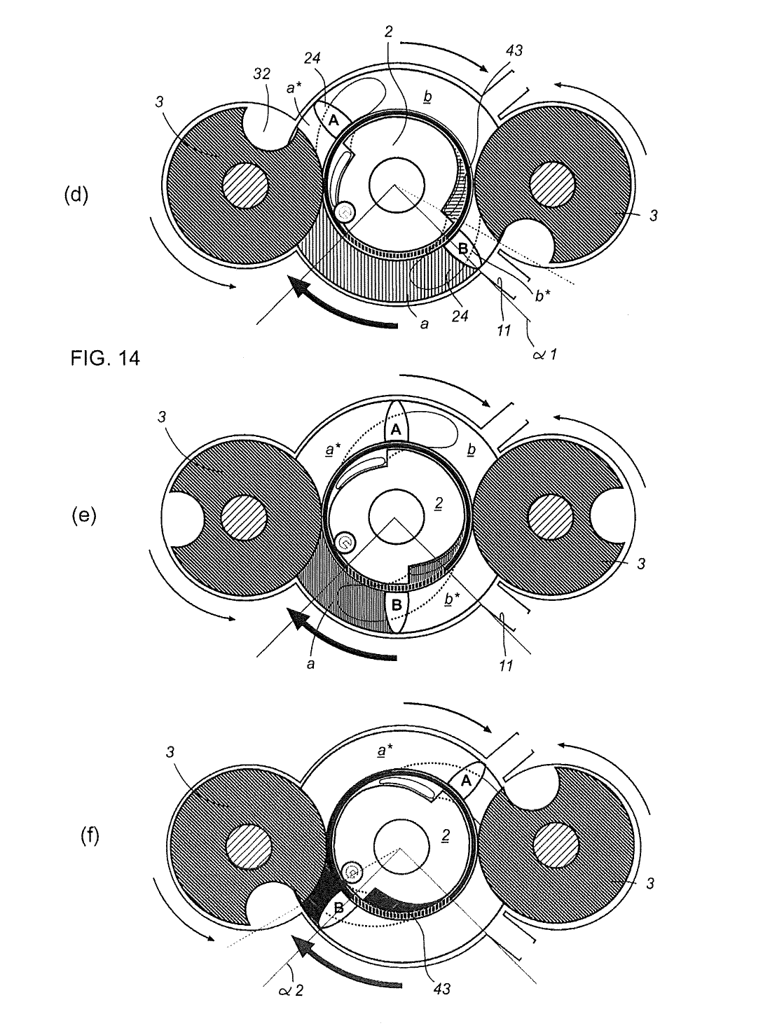

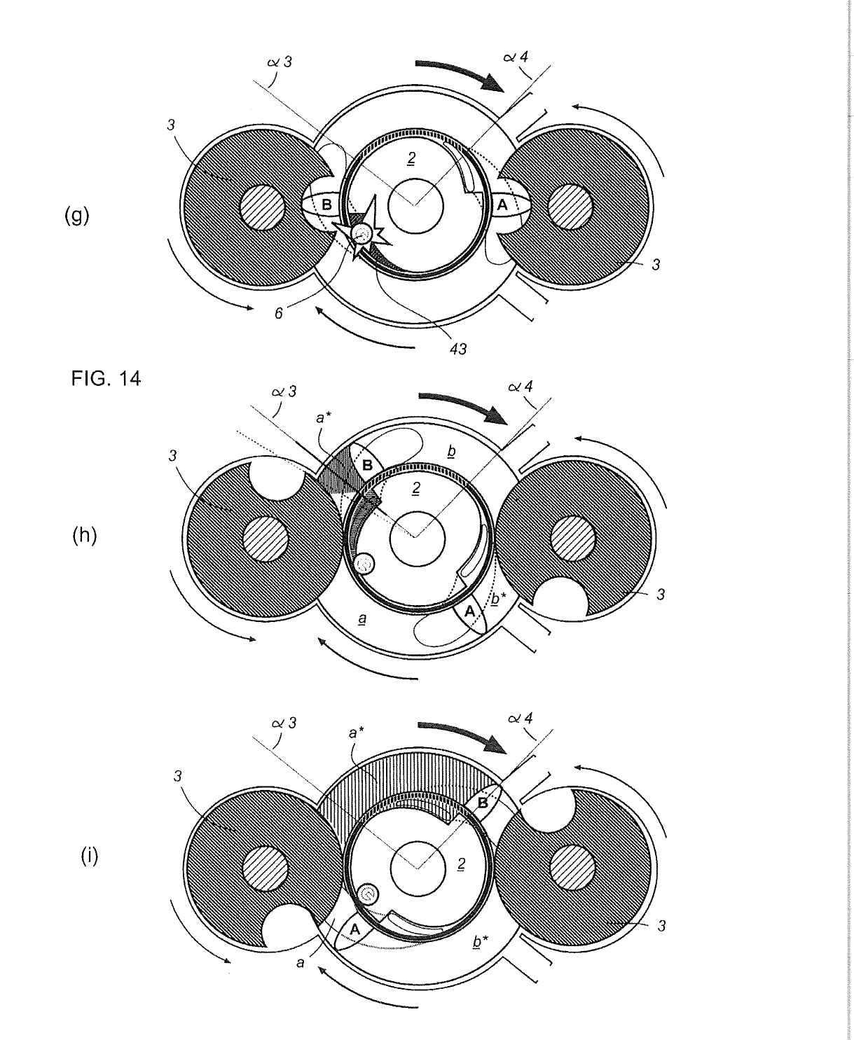

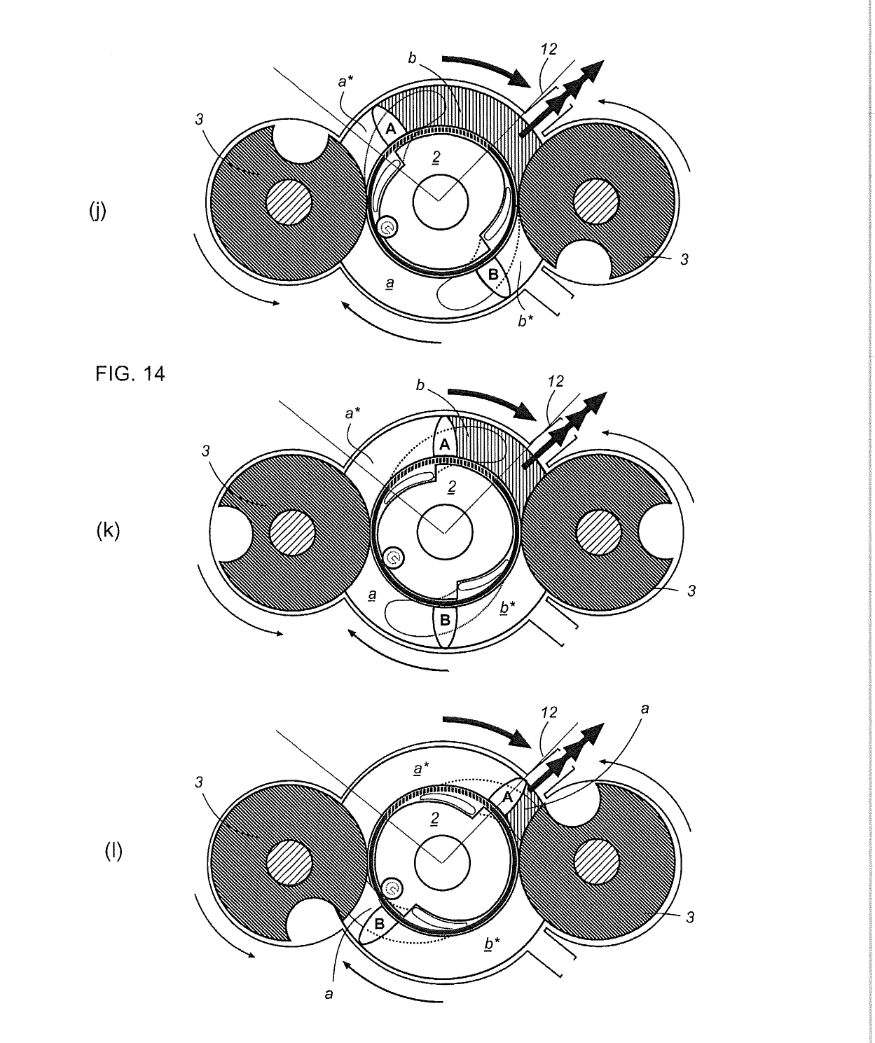

The housing 1 comprises at least one inlet 11 (cf. FIG. 14 a-l) for introducing the working gas into at least one of the working chambers a/a* and at least one outlet 12 (cf. FIG. 14 a-l) for discharging the working gas from at least one of the working chambers a/a*. Making use of a valve, the inlet 11 may simultaneously serve as outlet 12. For the sake of clarity, the housing 1, the inlet 11 and the outlet 12 are not shown in many figures.

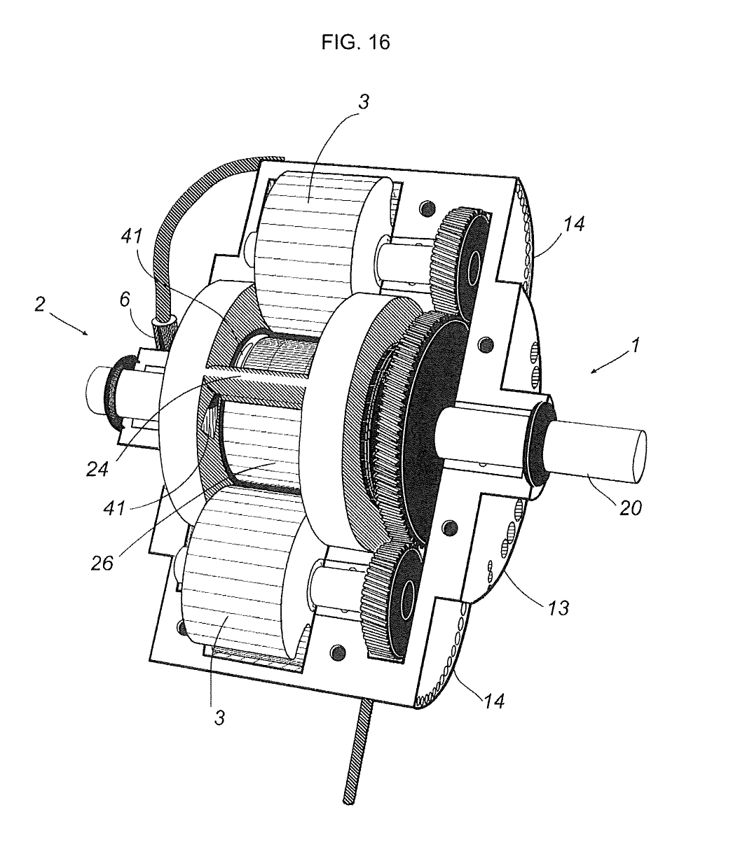

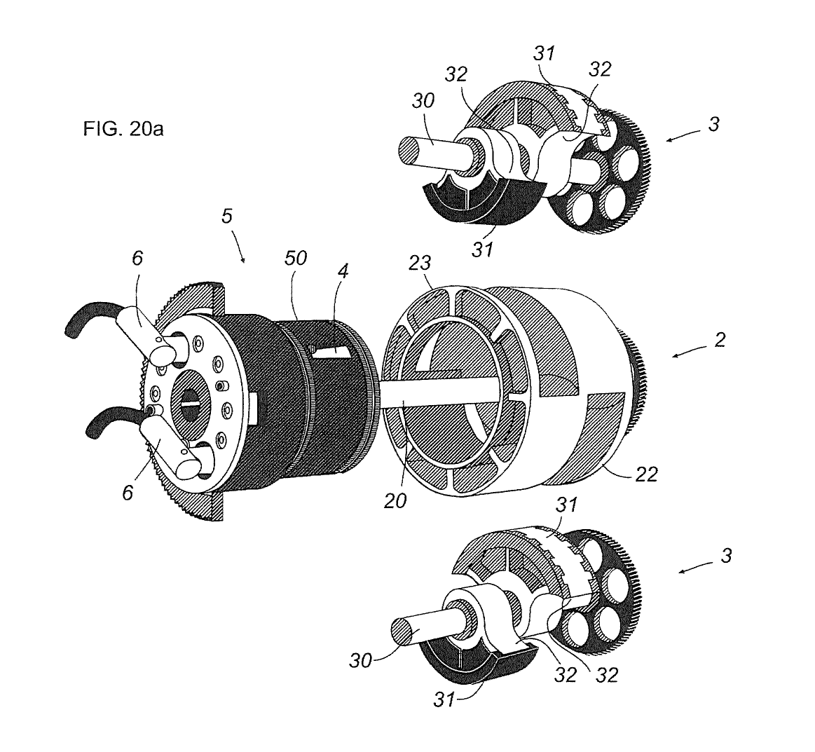

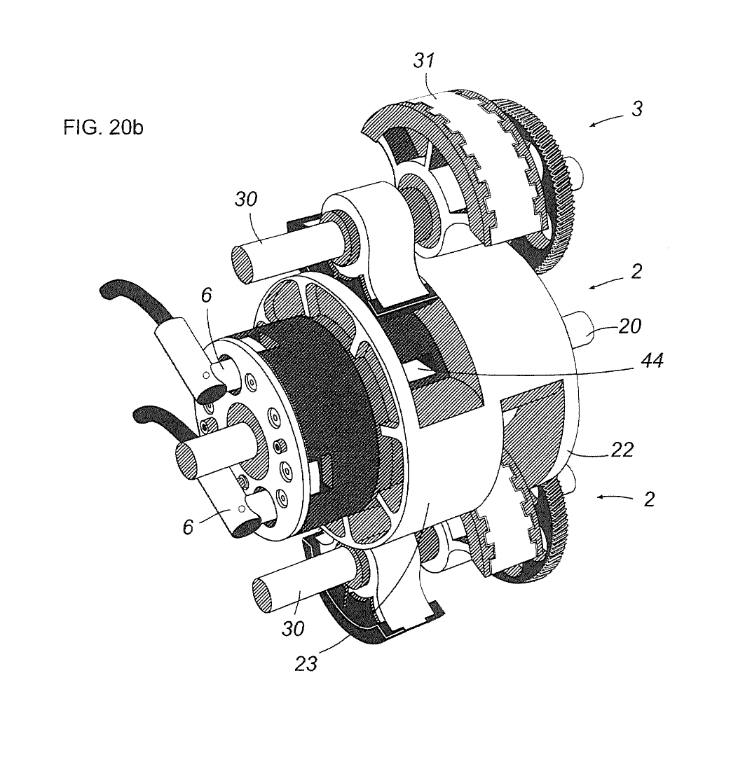

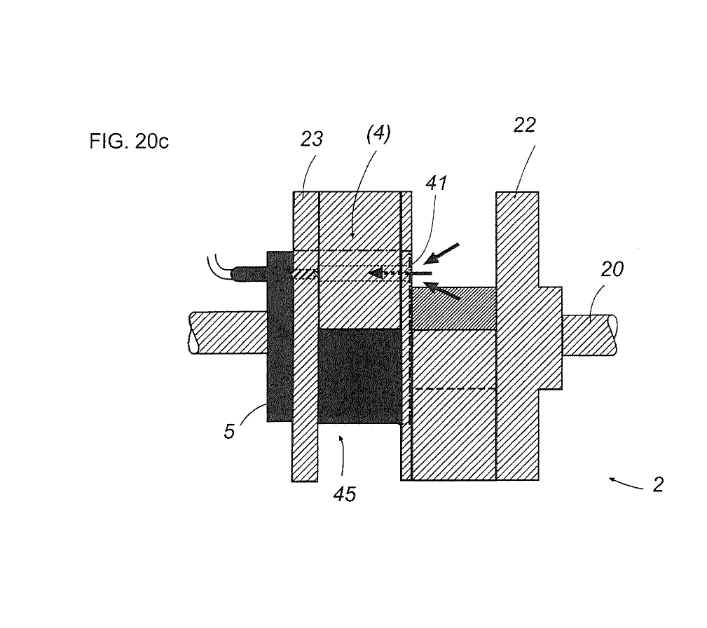

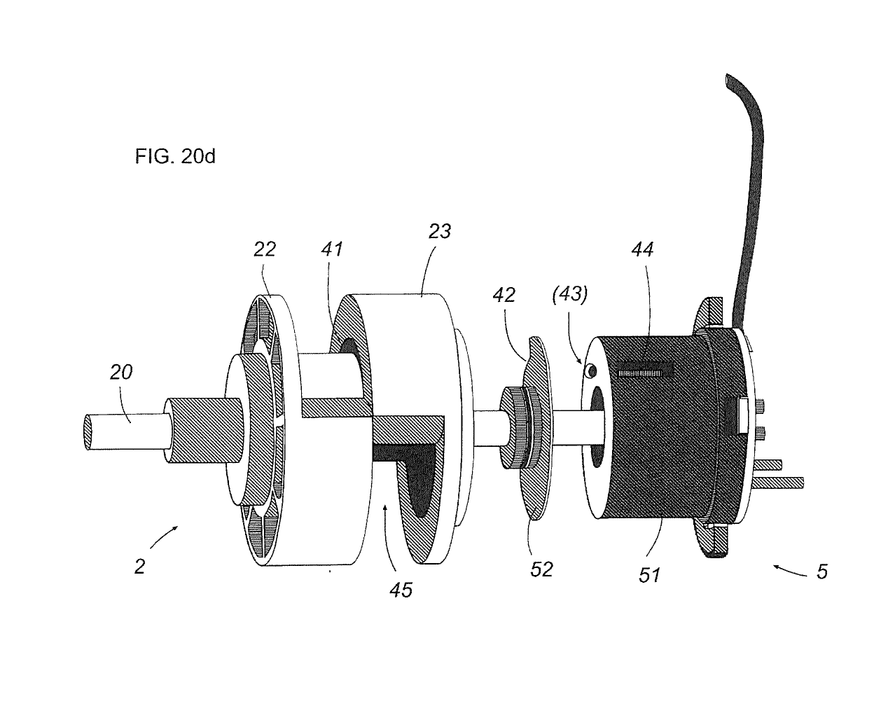

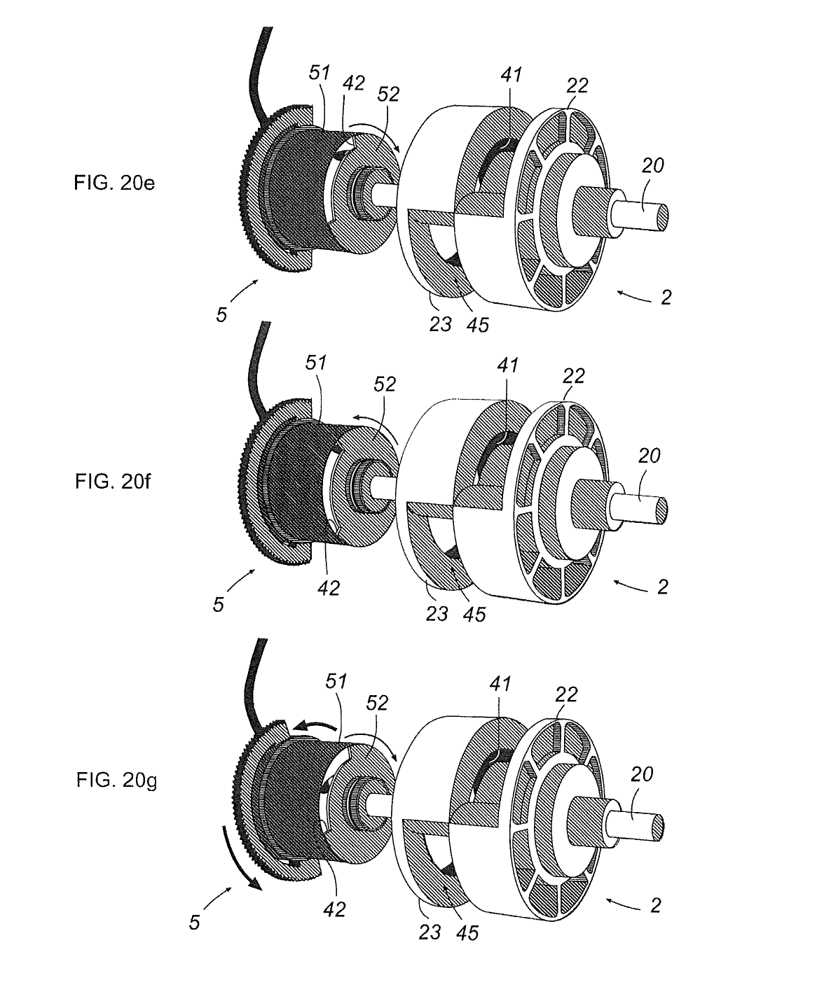

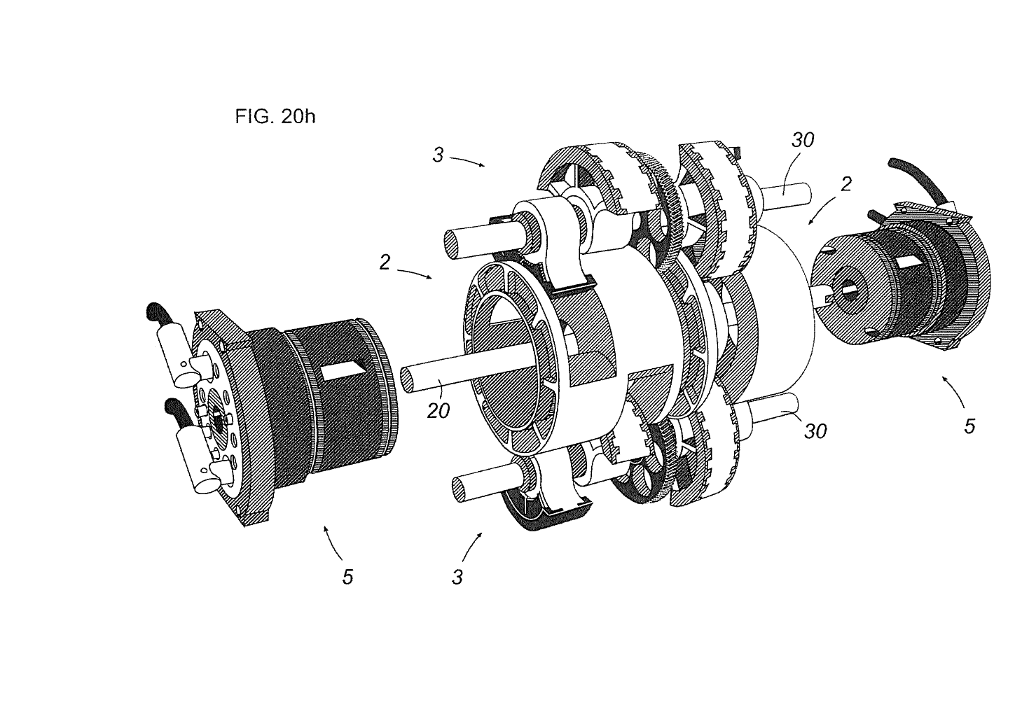

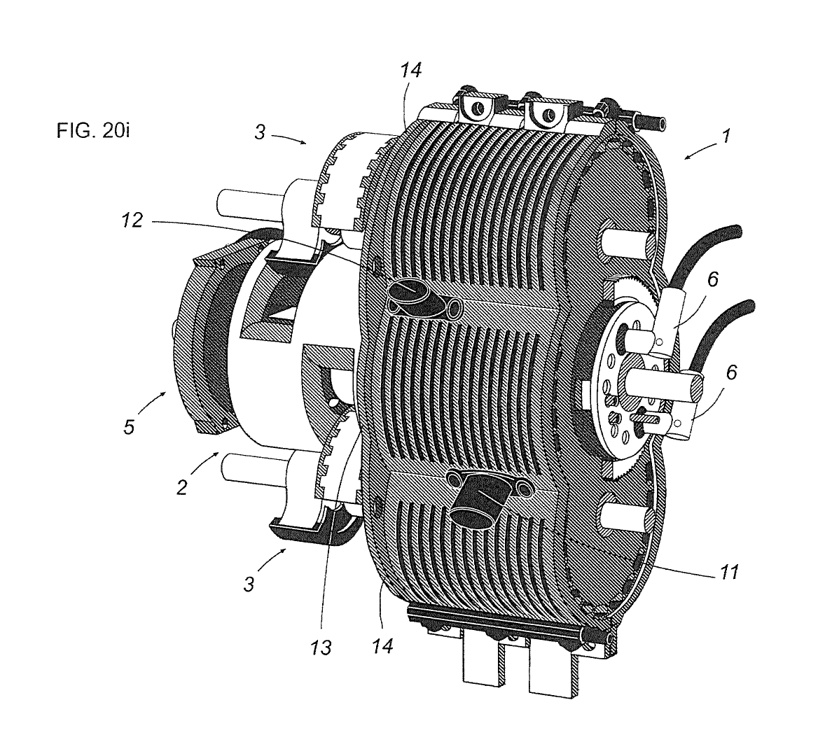

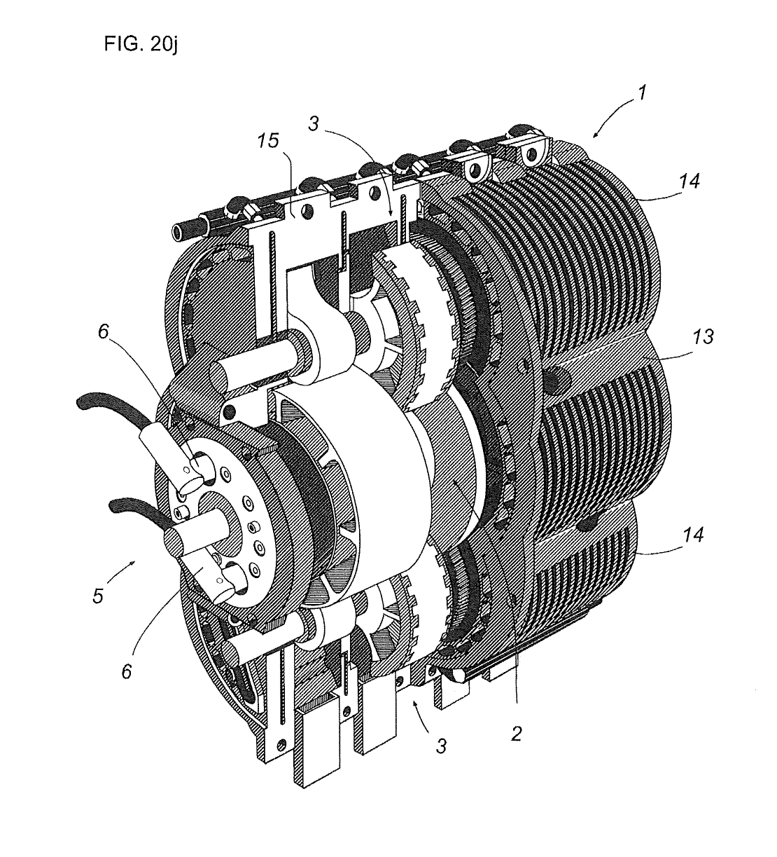

As can be seen e.g. in FIG. 16, the housing 1 is preferably configured such that, in a plane extending perpendicular to the axis of the working rotary piston 2, it has, on the outer side thereof, a curvature 13 about the axis of the working rotary piston 2 and at least one curvature 14 about the axis of at least one of the auxiliary rotary pistons 3. The curvature 13 about the axis of the working rotary piston 2 may have an arc length of approximately 120°. The curvature 14 about the axis of at least one of the auxiliary rotary pistons 3 has e.g. an arc length of at least 240°. This structural design proves to be particularly compact. On the outer side of the housing 1 cooling fins may be provided, said cooling fins having or defining preferably the above described curvatures 13, 14 (cf. FIG. 20 l, j).

The housing 1 is preferably mirror symmetric with respect to a plane defined by the axes of the working rotary piston 2 and of the at least one auxiliary rotary piston 3 and is divided in this plane. Two identical housing parts 15 can be connected in the plane of the axes of the working rotary piston 2 and of the at least one auxiliary rotary piston 3, so as to cover the working rotary piston 2 and the at least one auxiliary rotary piston 3 on different sides of their circumference, so that the working shaft 20 of the working rotary piston 2 and the auxiliary shafts 30 of the auxiliary rotary piston 3 can easily be accessed and mounted.

The working rotary piston 2 and the at least one auxiliary rotary piston 3 are sealed off from the housing 1 so as to form the working chambers a/a*. In the first embodiment, the working rotary piston 2 comprises a substantially cylindrical circumferential surface 21 with at least one pocket-shaped recess for forming at least one ignition chamber 43. The pocket-shaped recess is formed in that at the beginning of the recess, when seen in the direction of circulation of the working rotary piston 2, a radius of the circumferential surface 21 abruptly decreases and then increases again with a smaller gradient to the original value. Two side parts 22, 23 of the working rotary piston 2 are axially spaced from each other and connected by at least one separating section 24. Between the side parts 22, 23 the working rotary piston 2 delimits the working chambers a/a* on both sides in an axial direction and on at least one side by the separating section 24 in a circumferential direction. One of the side parts 22 is substantially circular, whereas the other side part 23 is substantially annular. On one of the side parts 22 a radially inner section 2a of the working rotary piston 2 is connected to a radially outer section 2b of the working rotary piston 2 so as to form on the other side part 23, between the radially inner section 2a and the radially outer section 2b, a reception means 25 for a gas passage unit 5 which is adapted to be adjustably fixed in position relative to the housing 1, said reception means 25 opening in an axial direction. Radially outside of the reception means 25 and the circumferential surface 21, a cover 26, which has the shape of a section of the circumferential surface of a cylinder, extends between the side parts 22, 23 subsequent to a separating bar 24 end defining the leading end in the direction of rotation, so as to radially delimit, at least sectionwise, the compression chamber a on the inner side. The cover 26 extends over only part of the circumference of the working rotary piston 2 so as to keep an opening 45 free, which extends over at least a part of the circumference of the working rotary piston 2 so that the duct 4 can communicate with the expansion chamber a* via the opening 45.

The gas passage unit 5 (cf. FIG. 10) is substantially hollow cylindrical and is adapted to be adjustably fixed in position on the housing 1 and to be rotated via a control unit and an actuator relative to the housing 1 in a circumferential direction. The gas passage unit 5 is adapted to be sealingly installed in the reception means 25 between the radially inner section 2a and the radially outer section 2b of the working rotary piston 2 and to be arranged coaxially with the working rotary piston 2 so as to surround the circumferential surface 21 of the working rotary piston 2 and define an ignition chamber 43 between the circumferential surface 21 and the side parts 22, 23. The ignition chamber 43 is configured in a substantially pocket-shaped manner axially within the working rotary piston 2 and rotates together with the working rotary piston 2 radially within the gas passage unit 5.

The auxiliary rotary piston 3 comprises a geometry complementary to that of the working rotary piston 2 so as to sealingly roll on the working rotary piston 2 and divide a space between the working rotary piston 2 and the housing 1 into a working chamber a* with increasing volume and a working chamber a with decreasing volume. The auxiliary rotary piston 3 and the working rotary piston 2 sealingly cooperate such that a working gas can be expelled completely from the working chamber a as the volume decreases. The separating section 24 of the working rotary piston 2 is adapted to be sealingly received in a reception portion 32 of the auxiliary rotary piston 3, said reception portion 32 being offset radially inwards relative to a circumferential surface 30 of the auxiliary rotary piston 3 which is substantially cylindrical in shape or has the shape of a cylinder section. The auxiliary rotary piston 3 is force-coupled to the working rotary piston 2 preferably via a toothed gear unit so that the rotational speeds of the working rotary piston 2 and the auxiliary rotary piston 3 are adapted to one another. Also other synchronization mechanisms (e.g. synchronous belt, upright shaft, etc.) are imaginable. The synchronization mechanism is preferably arranged within the housing 1.

The duct 4 can transfer the working gas from at least one of the working chambers a to at least one other of the working chambers a* and the working gas is allowed to flow therethrough in only one direction, viz. from a compression chamber a into an expansion chamber a*. To this end, the duct 4 can be closed on the inlet and on the outlet side thereof such that the duct 4 can communicate with only one of the working chambers a/a* at a time or that a working gas can temporarily be trapped in the duct 4. In particular, the duct 4 can, on the inlet side thereof, communicate with the compression chamber a only in a specific rotation angle range of the working rotary piston 2 and, on the outlet side thereof, communicate with the expansion chamber a* only in a rotation angle range of the working rotary piston 2 which is different from said first-mentioned range. In order to prevent inadvertent overflow of the working gas, it will be of advantage when the duct 4 can, on the inlet side thereof, only open towards the compression chamber a anyhow, and, on the outlet side thereof, only open towards the expansion chamber a*, so that the working gas can only flow into the duct 4 from the compression chamber a and flow out of the duct 4 only into the expansion chamber a*. To this end, the duct 4 comprises various duct portions 41, 42, 43, 44, 45, at least two of these duct portions 41, 42 and 44, 45, respectively, being adapted to be simultaneously aligned with one another so as to allow communication therebetween. Some of the duct portions 41, 45 rotate, whereas other duct portions 42, 44 are fixed in position relative to the housing 1.

In the first embodiment, the duct 4 is formed sectionwise in the side parts 22, 23 of the working rotary piston 2 and, on its inlet side, it branches off from an end of the compression chamber a, which is the trailing end in the direction of rotation of the working rotary piston 2, substantially tangentially to the circumference of the working rotary piston 2.

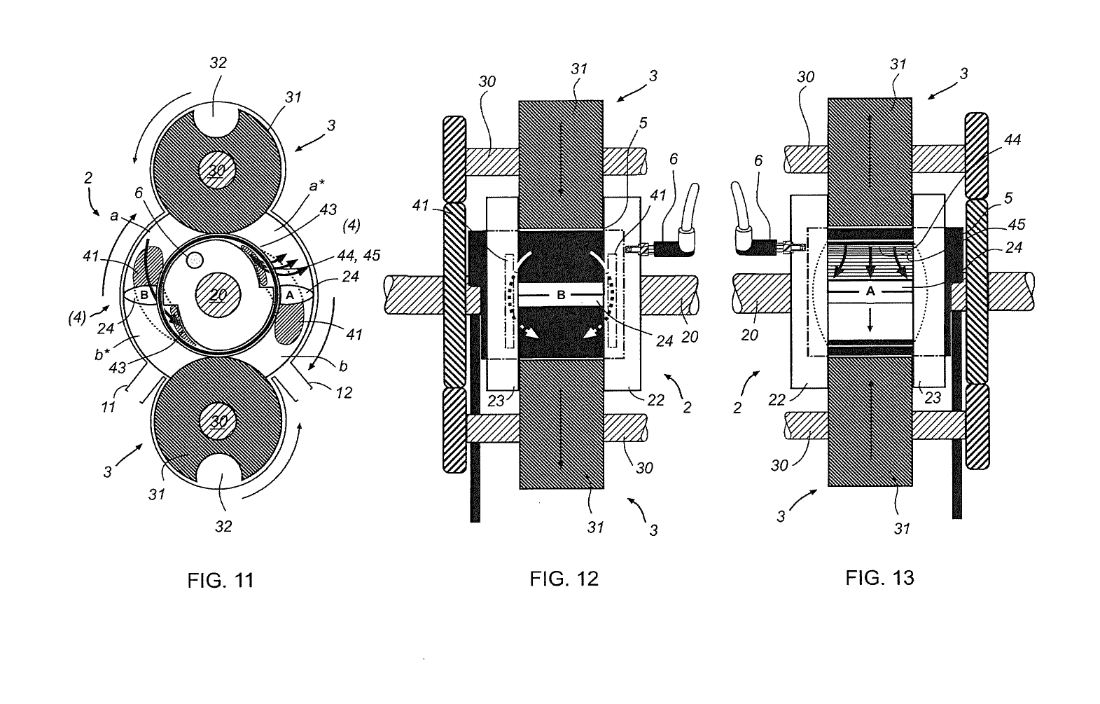

In the direction of rotation of the working rotary piston 2, a first duct portion 41 extends from the inlet-side opening with a substantially converging cross-section approximately spirally with decreasing radius in an axial and in a radial direction into the side parts 22, 23. The inlet-side opening of the duct 4, which is formed by the first duct portion 41, can be seen clearly in FIGS. 10 and 11. An angle defined by an axis of the duct 4 and the tangent on the circumference of the working rotary piston 2 in the area of the inlet-side opening is preferably not larger than 15°, measured in or opposite to the direction of rotation of the working rotary piston 2.

In a shiftable rotation angle range of the working rotary piston 2, a second duct portion 42, which leads through the gas passage unit 5, is adapted to be aligned with the first duct portion 41 of the working rotary piston 2 on the one hand and the ignition chamber 43, which forms a third duct portion 43, on the other, so as to transfer a working gas from the compression chamber a to the ignition chamber 43.

The duct 4 leads through the second duct portion 42 into the ignition chamber 43; the latter forms a third duct portion and opens divergently to a leading end of the expansion chamber a*, where the ignited working gas is expanded.

In a shiftable rotation angle range of the working rotary piston 2, a fourth duct portion 44, which also leads through the gas passage unit 5, is adapted to be aligned with the ignition chamber 43 on the one hand and the opening 45 of the expansion chamber a* on the other, so as to discharge the working gas from the ignition chamber 43 into the expansion chamber a*. The rotation angle ranges may be adjustable and shiftable individually or in common.

The opening 45 of the working rotary piston 2 forms the fifth duct portion.

The duct portions 42, 44 are substantially slot-shaped and extend in a circumferential direction through a circumferential surface 50 of the gas passage unit 5. The first and second duct portions 41, 42 as well as the fourth and fifth duct portions 44, 45 form here two groups of duct portions 41, 42; 44, 45, which, in the present case, are spaced apart at least in a circumferential direction and can therefore only communicate with one another in different rotation angle ranges of the working rotary piston 2.

The duct 4 opens, on its outlet side, substantially tangentially to the circumference of the working rotary piston 2 into the expansion chamber a*, so that the least possible amount of energy will get lost through deflection of the working gas. An angle defined by an axis of the duct 4 and the tangent on the circumference of the working rotary piston 2 in the area of the outlet-side opening amounts e.g. to 15°. The duct 4 opens, on its outlet side, at a front end in a circumferential direction and in a radial direction into the expansion chamber a* from inside, so as to discharge the expansion energy of the working gas almost with out any deflection in the direction of rotation of the working rotary piston 2. In the direction of flow, a cross-section of the duct 4 diverges on the outlet side so that the working gas is compressed still further upstream of the ignition chamber 43 and can already expand downstream of the ignition chamber. The opening 45, which defines the outlet-side opening of the duct 4, extends over the whole width or whole axial length of the expansion chamber a* and is many times larger than the inlet-side opening of the duct 4 so that the working gas can be discharged as fast as possible and with out any loss of energy into the expansion chamber a*. Due to the fact that the inlet-side opening of the duct 4 and the outlet-side opening of the duct 4 do not overlap in the circumferential direction of the working rotary piston 2, but are spaced apart by a rotation angle of at least 20°, a flowback of the working gas from the expansion chamber a* into the compression chamber a can always be prevented.

The working gas is ignited in the ignition chamber 43 by an igniter 6, which is fixed in position relative to the housing 1 and capable of communicating with the ignition chamber 43 e.g. via slot-shaped, closable openings.

FIG. 1 shows a schematic side view of parts of a rotary piston engine according to a first variant of the first embodiment of the present invention in a first operating phase for illustrating the compression process and the filling of the ignition chamber 43. In the view chosen, the working rotary piston 2 rotates clockwise and the auxiliary rotary piston 3 rotates anticlockwise. The directions of rotation of the pistons are indicated, where appropriate, by arrows also in the following figures. In relation to an axis of the working rotary piston 2, the separating bar 24 is in FIG. 1 approximately at the 9 o'clock position and the auxiliary rotary piston 3 approximately at the 12 o'clock position. The auxiliary rotary piston 3 divides a space between the housing 1 and the working rotary piston 2 into the compression chamber a, whose volume decreases during rotation of the working rotary piston 2, and the expansion chamber a*, whose volume increases during rotation of the working rotary piston 2. In the condition shown, the first duct portion (41, cf. FIG. 2) communicates with the second duct portion 42 and the ignition chamber 43 so that the working gas compressed in the compression chamber a is conducted via the duct 4 into the ignition chamber 43. At the rotational position shown, the duct 4 is covered and consequently closed on the outlet side, i.e. towards the side of the expansion chamber a*, so that the compressed working gas cannot escape from the ignition chamber 43.

FIG. 2 shows a schematic front view of parts of the rotary piston engine according to FIG. 1 in the first operating phase. The arrows illustrate the flow of the compressed working gas from the compression chamber a into the ignition chamber 43.

FIG. 3 shows a schematic side view of parts of the rotary piston engine according to FIG. 1 in a second operating phase for illustrating the expansion process and the emptying of the ignition chamber 43. In the condition shown, the ignition chamber 43 communicates with the fourth duct portion 44 and the opening 45 (cf. FIG. 4), so that the working gas ignited in the ignition chamber 43 is discharged via the duct 4 into the expansion chamber a*. At the rotational position shown, the duct 4 is covered and consequently closed on the inlet side, i.e. towards the side of the compression chamber a, so that the ignited working gas cannot escape into the compression chamber a.

FIG. 4 shows a schematic rear view of parts of the rotary piston engine according to FIG. 1 in the second operating phase. The arrows illustrate the flow of the compressed working gas from the ignition chamber 43 into the expansion chamber a*.

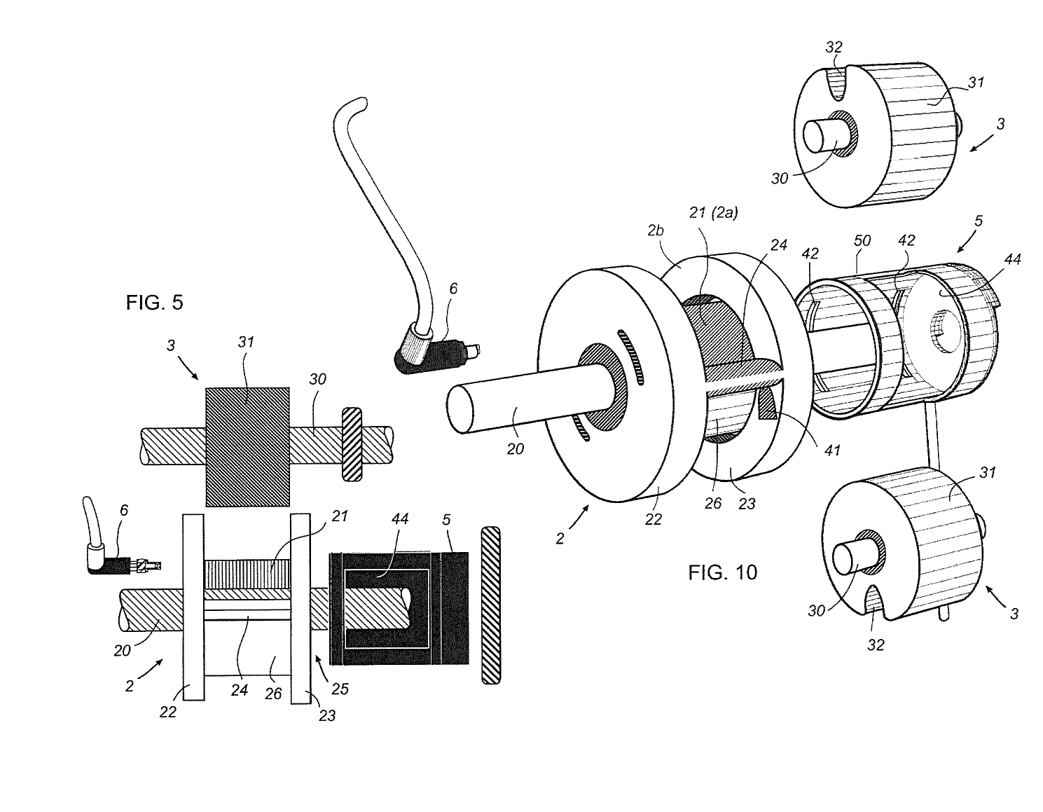

FIG. 5 shows a schematic exploded view of parts of the rotary piston engine according to FIG. 1.

FIG. 6 shows a schematic side view of parts of the rotary piston engine according to a second variant of the first embodiment of the present invention in a first operating phase for illustrating the compression process and the filling of the ignition chamber 43. Deviating from the first variant of the first embodiment, the working rotary piston 2 according to this second variant comprises two separating bars 24 and the auxiliary rotary piston 3 comprises two reception portions 32. Furthermore, in this second variant, the cover 26 extends over half the circumference of the working rotary piston 2 between two separating bars 24, a slot-shaped opening 41 extending between the cover 26 and each of the two side parts 22, 23 over half the circumference of the working rotary piston 2 in an axial direction. The slot-shaped openings 41 define together the first duct portion 41. The opening 45, which defines the fifth duct portion 45, extends over the other half of the circumference of the working rotary piston 2 over the whole axial length of the working rotary piston 2 between the side parts 22, 23, without, however, overlapping the openings 41 in an axial direction. In this half of the circumference of the working rotary piston 2, the axial distance between the inner sides of the side parts 22, 23 is smaller than that in the other half of the circumference. The working rotary piston 2 and the auxiliary rotary piston 3 are thus configured asymmetrically and they have an eccentric center of gravity. The center of gravity may possibly be re-aligned with the axis of the working rotary piston 2 by balancing holes, whereby a reduction in weight can be achieved as well. The second duct portion 42 and the fourth duct portion 44 are, similar to the first variant, formed in the gas passage unit 5 such that they can communicate with the first duct portion 41 in a shiftable rotation angle range and communicate with the fifth duct portion 45 in another shiftable rotation angle range. Also according to this variant, the auxiliary rotary piston 3 has a complementary geometry for sealingly rolling on the working rotary piston 2. In the view chosen, the working rotary piston 2 again rotates clockwise and the auxiliary rotary piston 3 rotates anticlockwise. In relation to an axis of the working rotary piston 2, the separating sections 24 are in FIG. 6 approximately at the 9 o'clock position and at the 15 o'clock position and the auxiliary rotary piston 3 approximately at the 12 o'clock position. The auxiliary rotary piston 3 divides a space between the housing 1 and the working rotary piston 2 into the compression chamber a and the expansion chamber a*, a further working chamber b being formed between the separating sections 24 on the side of the working rotary piston 2 facing away from the auxiliary rotary piston 3. In the condition shown, the first duct portion (41, cf. FIG. 7) communicates with the second duct portion 42 and the ignition chamber 43 so that the working gas compressed in the compression chamber a is conducted via the duct 4 into the ignition chamber 43. At the rotational position shown, the duct 4 is covered and consequently closed on the outlet side, i.e. towards the side of the expansion chamber a*, so that the compressed working gas cannot escape from the ignition chamber 43.

FIG. 7 shows a schematic front view of parts of the rotary piston engine according to FIG. 6 in the first operating phase.

FIG. 8 shows a schematic side view of parts of the rotary piston engine according to FIG. 6 in a second operating phase for illustrating the expansion process and the emptying of the ignition chamber 43. In the condition shown, the ignition chamber 43 communicates with the fourth duct portion 44 and the opening 45 (cf. FIG. 9) so that the working gas ignited in the ignition chamber 43 is discharged via the duct 4 into the expansion chamber a*. At the rotational position shown, the duct 4 is covered and consequently closed on the inlet side, i.e. towards the side of the compression chamber a, so that the ignited working gas cannot escape into the compression chamber a.

FIG. 9 shows a schematic rear view of parts of the rotary piston engine according to FIG. 6 in the second operating phase.

FIG. 10 shows a perspective exploded view of parts of the rotary piston engine 1 according to a third variant of the first embodiment of the present invention. Similar to the second variant, the working rotary piston 2 according to this third variant comprises two separating bars 24. However, two auxiliary rotary pistons 3, each including a reception portion 32, are provided. Each of the two auxiliary rotary pistons 3 has a complementary geometry for sealingly rolling on the working rotary piston 2, the auxiliary rotary pistons 3 being force-coupled to the working rotary piston 2 e.g. via a toothed gear unit (not shown), the axes of the working rotary piston 2 and of the auxiliary rotary pistons 3 being located in the same plane. This results in the formation of a total of four working chambers a/a*, b/b*, i.e. two compression chambers a,b and two expansion chambers a*,b*. Deviating from the two preceding variants, the working rotary piston 2 is provided with two pocket-shaped recesses for forming two identical ignition chambers 43, which are displaced by 180° in a circumferential direction. The rotary piston engine according to a third variant comprises two separate ducts 4 so as to establish communication between a respective one of the compression chambers a,b and a respective one of the expansion chambers a*,b*. To this end, the duct portions 41, 43, 45 formed in the working rotary piston 2 are substantially doubled in comparison with the first variant and displaced by 180° relative to one another. The opening 45, which defines the fifth duct portion 45, extends over the entire axial length of the working rotary piston 2 between the side parts 22, 23 and between two respective separating sections 24, without overlapping the openings 41 in an axial direction. Deviating from the second variant, the inner sides of the side parts 22, 23 are identically spaced in both halves of the circumference of the working rotary piston 2. The openings 41 are, similar to the first variant, formed in the side parts 22, 23 and define the first duct portion 41. The second duct portion 42 and the fourth duct portion 44 are, similar to the two preceding variants, formed in the gas passage portion 5 such that they can communicate with the first duct portion 41 of each duct 4 in a shiftable rotation angle range and with the fifth duct portion 45 of each duct 4 in another shiftable rotation angle range. The gas passage portion 5 is, however, configured such that the working gas is transferred only once from a working chamber to another working chamber during a rotation of the working rotary piston 2, so that a total of four different strokes will be executed during a rotation of the working rotary piston 2, the four working chambers a/a*, b/b* defining respectively an intake chamber b*, a compression chamber a, an expansion chamber a* and an exhaust chamber b.

FIG. 11 shows a schematic side view of parts of the rotary piston engine according to FIG. 10 in an operating phase for illustrating the compression process and simultaneously the expansion process, which are carried out at the same time. In the view chosen, the working rotary piston 2 rotates clockwise and the auxiliary rotary pistons 3 rotate anticlockwise. In relation to an axis of the working rotary piston 2, the separating sections 24 are in FIG. 11 approximately at the 9 o'clock position and at the 15 o'clock position and the auxiliary rotary pistons 3 are approximately at the 12 o'clock position and the 18 o'clock position. The auxiliary rotary pistons 3 divide the two spaces between the housing 1 and the working rotary piston 2 in two respective chambers a/a*, b/b*. On the 9 o'clock side of the working rotary piston 2 (cf. FIG. 12), the first duct portion (41, cf. FIG. 7) of one duct 4 communicates with the second duct portion 42 and the ignition chamber 43 of the same duct 4, so that the working gas compressed in the compression chamber a is conducted via the duct 4 into the ignition chamber 43. At the rotary position shown, this duct 4 is covered and consequently closed on the outlet side, i.e. towards the side of the expansion chamber b*, so that the compressed working gas cannot escape from the ignition chamber 43. On the 15 o'clock side of the working rotary piston 2 (cf. FIG. 13), the other ignition chamber 43 of the other duct 4 communicates simultaneously with the fourth duct portion 44 and the opening 45 of the other duct 4, so that the working gas ignited in the ignition chamber 43 is discharged via the duct 4 into the expansion chamber a*. At the rotational position shown, the other duct 4 is covered and consequently closed on the inlet side, i.e. towards the side of the compression chamber b, so that the ignited working gas cannot escape into the compression chamber b.

FIG. 14 a-l show schematic views of parts of the rotary piston engine according to a third variant of the first embodiment of the present invention in different operating phases of the rotary piston engine for illustrating the strokes of the rotary piston engine in more detail.

FIG. 14 a shows how the working gas is introduced in intake chamber b* via the inlet 11, the intake chamber b* being filled during the continued rotation of the working rotary piston 2 (cf. FIG. 14 b-c). The working gas is represented by the hatched area.

As the rotation of the working rotary piston 2 progresses, the separating section 24 A runs through the reception portion 32 of the auxiliary rotary piston 3; the working chamber a* containing the working gas now decreases in volume and is referred to as compression chamber a*.

As the rotation of the working rotary piston 2 progresses still further, the working gas in the compression chamber a* is increasingly compressed and, as soon as the separating section 24 B has reached a first predetermined rotation angle position α1 (cf. FIG. 14 d), transferred to the ignition chamber 43 in the above-described manner via the duct 4 that opens on the inlet side. As soon as the separating section 24 B has reached a second predetermined rotation angle position α2 (cf. FIG. 14 f), the duct 4 closes on the inlet side and traps the working gas in the ignition chamber 43.

At the rotational position shown in FIG. 14 g, the working gas is ignited in the ignition chamber 43 via the igniter 6.

When the separating section 24 B reaches a third predetermined rotation angle position α3 (cf. FIG. 14 h), the duct 4 opens on the outlet side so as to discharge the ignited and expanding working gas substantially tangentially onto the circumference of the working rotary piston 2 and into the expansion chamber a*. The expansion energy of the expanding working gas drives the separating section 24 B and consequently the working rotary piston 2 in the direction of rotation.

Only when the separating section 24 B moves beyond a fourth predetermined rotation angle position α4 (cf. FIG. 14 i), the working gas will be able to flow off through the outlet 12.

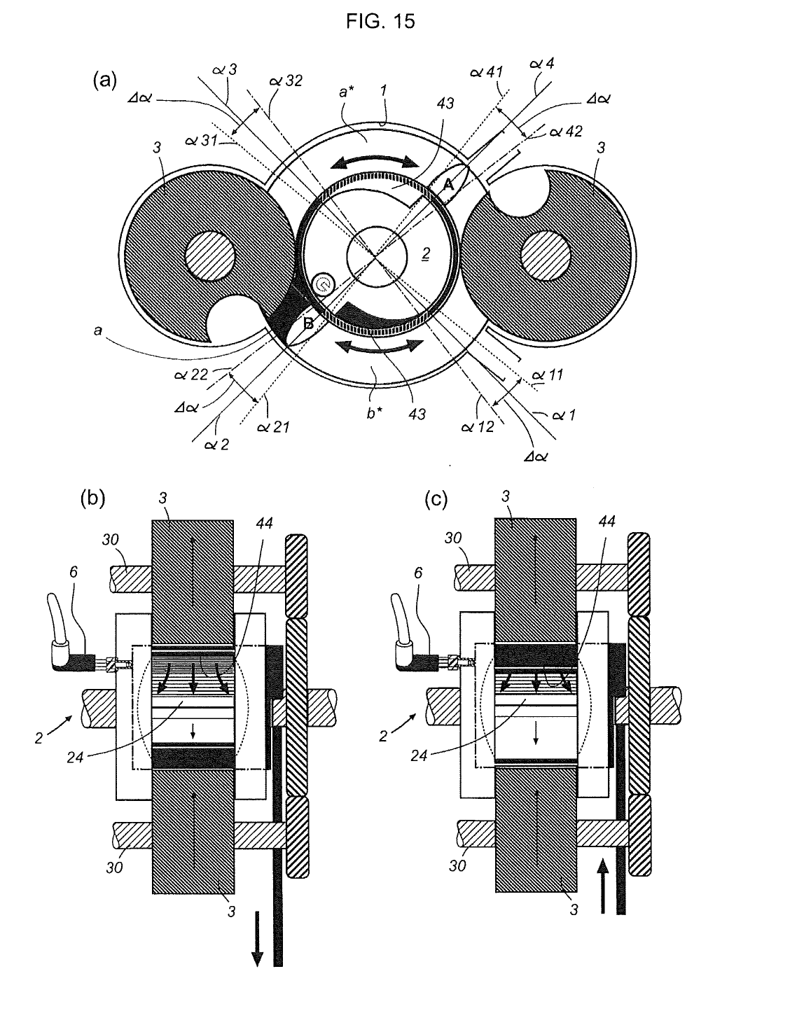

When the rotation of the working rotary piston 2 progresses still further, the separating section 24 B runs through the reception portion 32 of the second auxiliary rotary piston 3; the working chamber a* containing the working gas now decreases in volume once more and is referred to as exhaust chamber b. The working gas is forced out of the exhaust chamber b (cf. FIG. 14 j-l). Subsequently, the cycle can start once more beginning with the condition according to FIG. 14 a. FIG. 15 a-c show various schematic views for illustrating the adjustability of the gas passage portion 5 relative to the housing 1 of the rotary piston engine according to the third variant of the first embodiment of the present invention. FIG. 15 a shows a schematic side view of the rotary piston engine according to FIG. 14 a-l, said FIG. 15 a showing that, by rotating the gas passage portion 5 relative to the housing 1 of the rotary piston engine about the axis of the working rotary piston 2, the rotation angle range α1-α2, in which the duct 4 can communicate with the compression chamber a on its inlet side, and the rotation angle range α3-α4, in which the duct 4 can communicate with the expansion chamber a* on its outlet side, can be shifted in common. The rotation angles α1, α2, α3, α4 can thus be shifted by rotating the gas passage unit 5 relative to the housing 1 in and opposite to the direction of rotation of the working rotary piston 2 by an angle Δα between first extreme values α11, α21, α31, α41 and second extreme values α12, α22, α32, α42. As can be seen in FIG. 15 b-c, the rotation of the gas passage portion 5 relative to the housing 1 in the direction of rotation of the working rotary piston 2 has the effect that e.g. the second duct portion 44 moves from a first position (FIG. 15 b) through an angle Δα further in the direction of rotation of the working rotary piston 2 to a second position (FIG. 15 c), so that the duct 4 will later open on the outlet side and the ignited working gas will later be discharged into the expansion chamber a*. By varying the rotation angle ranges α1-α2 and α3-α4, the efficiency of the rotary piston engine can be optimized for various cases of load or in various speed ranges. Preferably, the rotation of the gas passage portion 5 relative to the housing 1 is accomplished by an open-loop control and/or a closed-loop control depending on various operating parameters of the rotary piston engine, e.g. a speed or a torque of the working rotary piston 2.

### Second Embodiment

The decisive difference between the second embodiment and the first embodiment essentially is that the ignition chamber 43 is fixed in position relative to the housing 1 and the working rotary piston 2 rotates about the ignition chamber 43. The working rotary piston 2 has here substantially the shape of a hollow cylinder, the compressed working gas being conducted by the working rotary piston 2 radially inwards into the ignition chamber 43 for the purpose of ignition. The ignition chamber 43 is formed in the gas passage unit 5 which is adjustably fixed in position relative to the housing 1.

FIG. 17 a-d show various perspective views of parts of the rotary piston engine according to a first variant of the second embodiment of the present invention, which is based on the first variant of the first embodiment. The mode of operation of this variant is substantially identical to the mode of operation of the first variant of the first embodiment, except for the fact that the ignition chamber 43 is fixed in position on the housing 1. It can clearly be seen in the schematic views that a path through the duct 4 between an inlet-side opening and an outlet-side opening of the duct 4 is shorter than an arc length about the axis of the working rotary piston 2 between the inlet-side opening and the outlet-side opening of the duct 4, so that the duct 4 reduces the length of the working gas path.

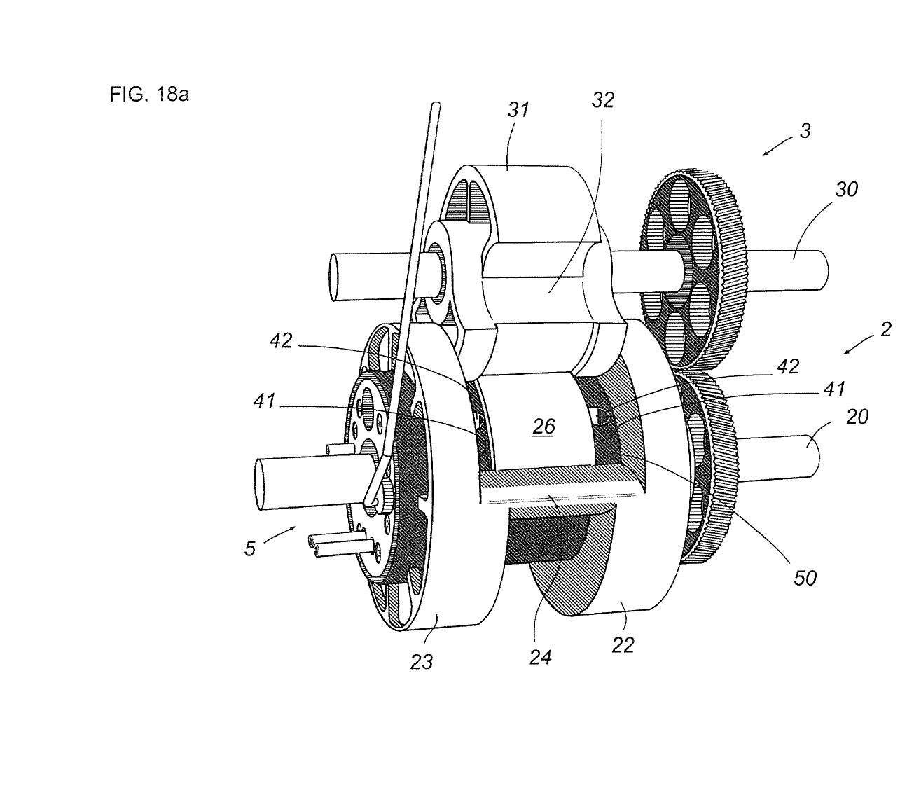

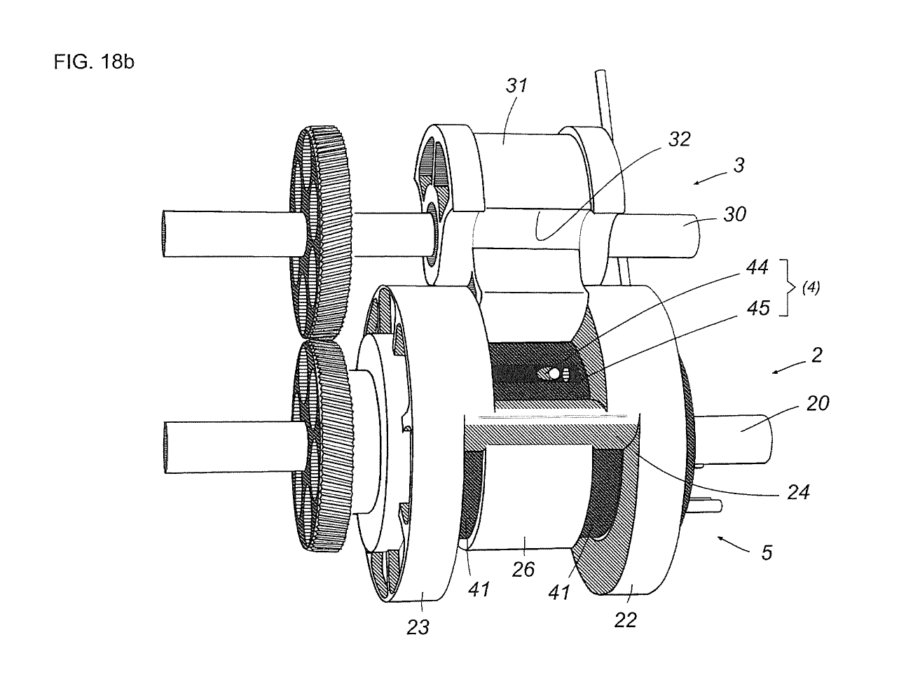

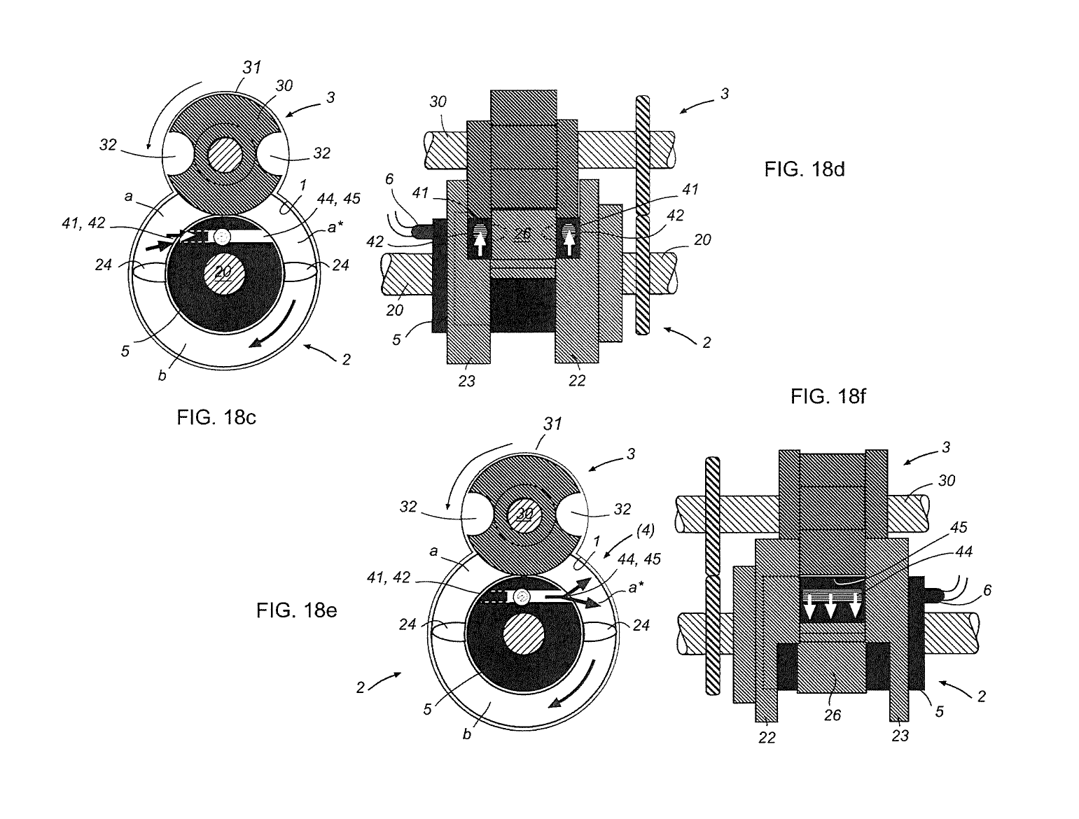

FIG. 18a-f show various views of parts of the rotary piston engine according to a second variant of the second embodiment of the present invention, which is based on the second variant of the first embodiment. According to this variant the working chambers have different cross-sectional shapes, the working chamber having the larger cross-sectional shape defining the compression chamber. The working rotary piston 2 is, in principle, configured identically to the working rotary piston 2 of the second variant of the first embodiment and rotates about the gas passage unit 5. At the rotational position shown in FIG. 18 a, the duct 4 can communicate on its inlet side with the compression chamber via the first duct portion 41 and the second duct portion 42. Other than in the case of the second variant of the first embodiment, the second duct portion 42 is not slot-shaped, but comprises substantially two circular openings extending from a circumferential surface 50 into the gas passage unit 5. In FIG. 18 b it can be seen how the duct 4 can, on its outlet side, communicate with the expansion chamber via the fourth duct portion 44 and the fifth duct portion 45. The shape of the fourth duct portion 44 is slightly different from that according to the second variant of the first embodiment. The compression process and the expansion process, however, take place analogously to the first embodiment. The representations of FIG. 18 c-f correspond essentially to those of FIG. 6-9.

FIG. 19 shows a perspective view of parts of the rotary piston engine according to a third variant of the second embodiment of the present invention, which is based on the third variant of the first embodiment. The rotary piston engine comprises here a working rotary piston 2 and two auxiliary rotary pistons 3, each including two reception portions 32. The basic functional principle is identical to that of the first embodiment.

FIG. 20 a-j show different views of parts of the rotary piston engine according to a fourth variant of the second embodiment of the present invention, which is based on the third variant of the first embodiment. In FIG. 20 a, parts of the rotary piston engine are shown in an exploded view so that the structural design and the cooperation of these parts can be seen in a particularly clear manner. The specific characteristic of this variant is to be seen in that the working chambers are spaced apart in an axial direction of the working rotary piston 2 and do not overlap in the circumferential direction of the working rotary piston 2. In addition, the working chambers are slightly displaced in a radial direction, so that the working gas can be conducted in an axial direction from the compression chamber into the inlet-side opening of the duct 4. The auxiliary rotary pistons 3 have corresponding complementary geometries for sealingly rolling on the working rotary piston 2. The reception portions 32 extend here over at least half the length of the circumference of the auxiliary rotary pistons 3. This representation shows clearly that the working rotary piston 2 and the auxiliary rotary pistons 3 may be provided with precisely defined cavities between rib-shaped structures for the purpose of stiffening, weight reduction and balancing. FIG. 20 b shows the parts of FIG. 20 a in a mounted condition. FIG. 20 c schematically illustrates the principle of introducing the working gas from the compression chamber into the duct 4 in an axial direction via the inlet-side opening. FIG. 20 d-j show various perspective views of parts of this rotary piston engine. FIG. 20 d represents an explosion-type perspective view of the working rotary piston 2 and of the gas passage unit 5. According to this variant, the gas passage unit 5 comprises two gas passage portions 51, 52 which are adapted to be rotated relative to one another in the circumferential direction of the working rotary piston 2 and each of which includes at least one portion 42, 44 of the duct 4. The portions 42, 44 of the duct 4 communicate with each other via the ignition chamber 43, while the gas passage portions 51, 52 can be displaced. It is thus possible to change a rotation angle position of the working rotary piston 2 relative to the housing 1, at which the duct 4 can communicate with the inlet-side working chamber. The first gas passage portion 51 is substantially configured as a hollow cylinder and includes the third duct portion (ignition chamber) 43 as well as the fourth duct portion 44, the third duct portion (ignition chamber) opening on the inlet side in an axial direction towards the side of the compression chamber. The second gas passage portion 52 is substantially configured as a circular disk-shaped body and includes the second duct portion 42, which is configured as a substantially arcuate indentation on the circumferential edge of the circular disk-shaped body. The second gas passage portion 52 is adapted to be rotated relative to the first gas passage portion 51 in the circumferential direction of the working rotary piston 2 such that the respective duct portions 42, 43, 44 will always be able to communicate, as illustrated in FIG. 20 e-g. FIG. 20 h shows a perspective view of a mirror-symmetric arrangement of two component assemblies according to this third variant, the working rotary pistons 2 and two respective auxiliary rotary pistons 3 being preferably positioned on shafts 20, 30 which they have in common and being adjusted such that the component assemblies carry out different strokes at the same time. A particularly high running smoothness of the rotary piston engine 1 can be achieved in this way. FIG. 20 i-j show different perspective views of parts of this rotary piston engine 1 with a partially open housing 1. The parting plane 15 and the curvatures 13, 14 of the housing 1 as well as rib-shaped structures on the outer wall of the housing 1, which contribute to the cooling of the rotary piston engine 1, are clearly visible. For each of the two component assemblies, which each comprise a working rotary piston 2 and two auxiliary rotary pistons 3 as well as a gas passage unit 5, two symmetric housing parts can be connected in the parting plane 15 through fastening means. The gas passage units 5 are again adapted to be rotated relative to the housing 1. Various adjustment possibilities are obtained in this way.

FIG. 21 a-e show various perspective views of parts of the rotary piston engine according to a fifth variant of the second embodiment of the present invention, which is based on the third variant of the first embodiment. The specific characteristic of this variant is essentially to be seen in that the rotary piston engine comprises a post-compressor 7 for post-compressing a working gas mechanically and/or pneumatically and/or hydraulically when it has left the compression chamber a and before it is introduced in the expansion chamber a*. To this end, the post-compressor 7 comprises e.g. reciprocating piston compressor with a compression chamber 70 at one end of a reciprocating piston 71 driven by a cam 72 on the working shaft 20 so as to carry out a translational movement, the cam 72 rotating with the same angular speed as the working rotary piston 2. The post-compressor 7 is formed radially and axially within the gas passage unit 5 and compresses the working gas directly within the compression chamber 70. In this embodiment, the duct 4 conducts the working gas exclusively through the post-compressor 7 so that the whole working gas is additionally compressed between the compression chamber a and the expansion chamber a* in the post-compressor. The post-compressed working gas may possibly be ignited when it is still in the duct 4, e.g. within the post-compressor 7, and is then discharged via the outlet side of the duct 4 into the expansion chamber a*. As has been described in the first embodiment, the duct 4 can communicate on its inlet side and on its outlet side with the compression chamber a and the expansion chamber a*, respectively. This variant ideally unites the advantages of the rotary piston principle and of the reciprocating piston principle, since the working gas can be compressed extremely within the post-compressor, the expansion energy of the working gas being, however, directly convertible into the rotational movement of the working rotary piston 2. A further special characteristic of this variant essentially resides in that the working rotary piston 2 comprises seal strips 27, which, preferably by means of a spring, are biased radially outwards for sealing each separating section 24 of the working rotary piston 2 off from the auxiliary rotary piston 3, the seal 27 being secured in position on the working rotary piston 2 in a form-fit manner.

FIG. 22 a-b show various perspective views of parts of the rotary piston engine according to a sixth variant of the second embodiment of the present invention, which is based on the fourth and fifth variants of the second embodiment. According to this variant, the post-compressor 7 comprises a reciprocating piston compressor with two compression chambers 70 at opposed ends of the reciprocating piston 71, which is driven by the cam 72 on the working shaft 20 so as to carry out a translational movement. A working gas, which is conducted into the compression chamber 70 via different ducts 4, is here alternately compressed in one of the compression chambers 70, the compression within the post-compressor being adapted to the strokes of the rotary piston engine. In FIG. 21 a the reciprocating piston 71 is located at the top dead center and in FIG. 21 b it is located at the bottom dead center.

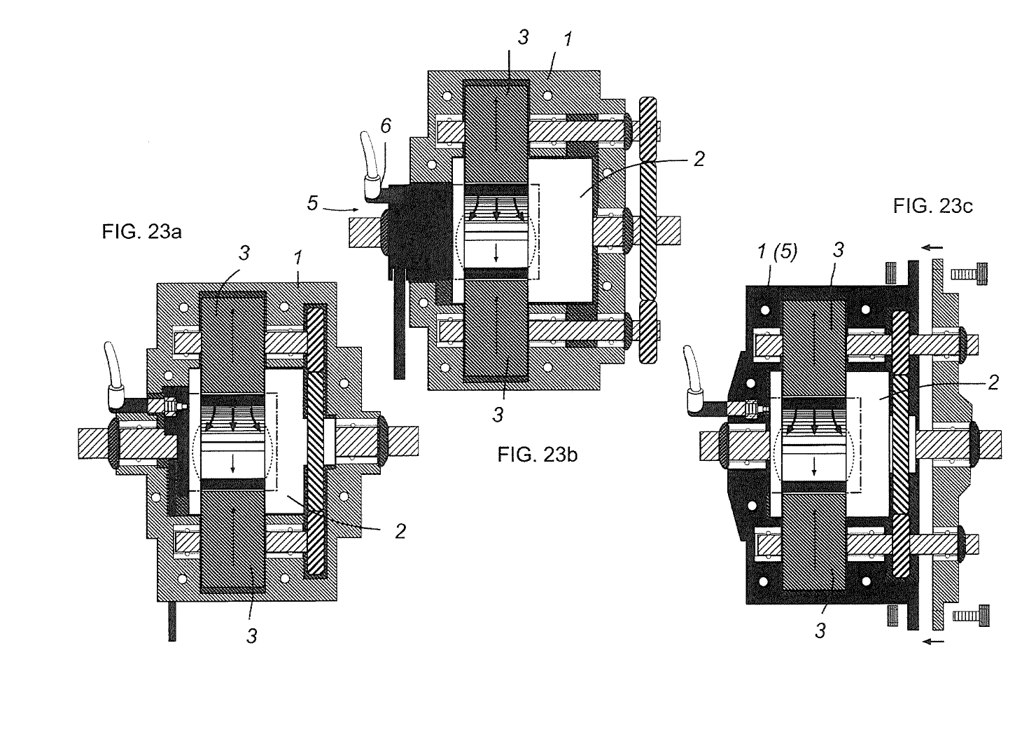

Finally, FIG. 23 a-c show various schematic sectional views through rotary piston engines with different embodiments of gas passage units 5, wherein the gas passage unit 5 in FIG. 23 a is secured in position on the housing 1 from inside, in FIG. 23 b it is secured in position on the housing 1 from outside and in FIG. 23 c it defines part of the housing 1.

Summarizing, the rotary piston engine according to the present invention offers the following advantages:
The length of the gas conducting paths is reduced and gas transfer is improved with due regard to gas dynamics (flow velocities and flow resistances), especially at high speeds.
Combustion residues in the compression chamber are avoided and the ignition chamber as well as the combustion chamber can be flushed so as to accomplish better combustion.
Frictional heat and frictional resistances as well as frictional heat-dependent expansion problems through the rotating parts to be sealed in the housing are reduced.
Oil lubrication is improved with due regard to high revolution speeds, and unintentional oil contamination of the compression chamber and of the expansion chamber is avoided.
Gas sealing of the compression chamber and of the expansion chamber is improved for higher power output with due regard to the construction-dependent gas conduction and gas transfers as well as possible material expansion.
The power to weight ratio and the efficiency are improved and greater flexibility and modularity is accomplished as regards the usability of the engine with respect to different fuels and different fields of use.

The present invention is not limited to the embodiments and variants described. The features of the individual embodiments and variants can be interchanged at will. Additional advantageous further developments may thus be obtained by arbitrary combinations of the features disclosed.

### REFERENCE NUMERALS

1 housing
2 working rotary piston
2a inner section
2b outer section
3 auxiliary rotary piston
4 duct
5 gas passage unit
6 igniter
7 post-compressor
11 inlet
12 outlet
13 curvature of the housing
14 curvature of the housing
15 parting plane of the housing
20 working shaft
21 circumferential surface
22 first side part
23 second side part
24 separating bar
25 reception means
26 cover
27 seal
30 auxiliary shaft
31 circumferential surface
32 reception portion
41 first duct portion (inlet-side opening)
42 second duct portion (inlet-side opening)
43 third duct portion (ignition chamber)
44 fourth duct portion (outlet-side opening)
45 fifth duct portion (outlet-side opening)
50 circumferential surface
51 first gas passage portion
52 second gas passage portion
70 compression chamber
71 reciprocating piston
72 cam
α1 first rotation angle
α2 second rotation angle
α3 third rotation angle
α4 fourth rotation angle

1. A rotary piston engine comprising at least two working chambers formed by a housing, a working rotary piston rotating therein and at least one rotating auxiliary rotary piston, wherein a working gas can be transferred via at least one duct from at least one of the working chambers into at least one other of the working chambers.

2. The rotary piston engine according to claim 1, wherein the housing fulfills at least one of the following requirements:
a. the housing comprises at least one inlet for introducing a working gas in at least one of the working chambers;
b. the housing comprises at least one outlet for discharging a working gas from at least one of the working chambers;
c. the housing is configured such that, in a plane extending perpendicular to the axis of the working rotary piston the housing has, on the outer side thereof, a curvature about the axis of the working rotary piston and/or a curvature about the axis of at least one of the auxiliary rotary pistons, the curvature having an arc length of at least 45°;
d. the housing is mirror symmetric with respect to a plane defined by the axes of the working rotary piston and of the at least one auxiliary rotary piston;
e. the housing comprises at least two parts, for covering the working rotary piston and the at least one auxiliary rotary piston on different sides of their circumference;
f. the housing is divided substantially in a first plane defined by the axes of the working rotary piston and of the at least one auxiliary rotary piston, or in a plane which is parallel to the plane; and
g. the housing surrounds a synchronization mechanism for synchronizing the working rotary piston and the at least one auxiliary rotary piston.

3. The rotary piston engine according to claim 1, wherein the working rotary piston fulfills at least one of the following requirements:
a. the working rotary piston delimits at least one of the working chambers in an axial direction at least on one side;
b. the working rotary piston delimits at least one of the working chambers in a circumferential direction at least on one side;
c. the working rotary piston delimits at least one of the working chambers in a radial direction at least on one side;
d. the working rotary piston is broader than at least one of the auxiliary rotary piston;
e. the working rotary piston overlaps at least one of the auxiliary rotary pistons in an axial direction at least on one side;
f. the working rotary piston is configured substantially as a hollow cylinder;
g. the compressed working gas is, for the purpose of ignition, conducted through the working rotary piston;
h. the working rotary piston comprises a substantially cylindrical circumferential surface with at least one pocket-shaped recess for forming at least one duct portion and/or at least one ignition chamber, wherein a radius of the circumferential surface decreases abruptly in the direction of circulation of the working rotary piston at the beginning of the recess and then increases again with a smaller gradient to the original value;
i. the working rotary piston comprises two side parts, which are spaced apart in an axial direction and which define therebetween at least one of the working chambers, at least one of the side parts being, at least sectionwise, circular or annular in shape;
j. the working rotary piston comprises at least one separating section for separating at least two of the working chambers from one another, the separating section extending preferably in an axial and/or radial direction of the working rotary piston for connecting two side parts of the working rotary piston;
k. the working rotary piston comprises at least one reception means for at least one gas passage unit;
l. the working rotary piston comprises a radially inner section and a radially outer section, which are interconnected on a side part of the working rotary piston, a reception means for a gas passage unit being provided on another side part of the working rotary piston between the radially inner section and the radially outer section, said reception means opening in an axial direction;
m. the working rotary piston defines or comprises at least one portion of the duct, which is adapted to be aligned with at least one other portion of the duct, such that the duct portions can communicate, the portion of the duct being defined, at least sectionwise, by a circumferential surface and/or by a side part of the working rotary piston;
n. the working rotary piston comprises at least one portion of the duct which extends through the working rotary piston, the portion of the duct being slot-shaped and extending in a circumferential direction of the working rotary piston;
o. the working rotary piston comprises a cover having the shape of a section of the circumferential surface of a cylinder and which is located subsequent to a separating bar end defining the leading end in the direction of rotation, so as to delimit, at least sectionwise, at least one of the working chambers in a radial direction on the inner side, the cover extending preferably over only part of the circumference of the working rotary piston so as to keep an opening free, which extends over at least part of the circumference of the working rotary piston so that the duct can communicate with at least one of the working chambers, via the opening;
p. the working rotary piston is configured asymmetrically;
q. the working rotary piston comprises elements for stiffening and/or elements for controlling thermal expansion and/or elements for balancing;
r. the working rotary piston has an eccentric center of gravity;
s. the working rotary piston is sealed off from the housing; and
t. the working rotary piston comprises at least one seal biased radially outwards for sealing a separating section-PO of the working rotary piston off from the at least one auxiliary rotary piston, the seal being secured in position on the working rotary piston.

4. The rotary piston engine according to claim 1, wherein at least one of the rotating auxiliary rotary pistons fulfills at least one of the following requirements:
a. the auxiliary rotary piston is arranged in the housing;
b. the auxiliary rotary piston comprises a geometry complementary to that of the working rotary piston;
c. the auxiliary rotary piston sealingly rolls on the working rotary piston;
d. the auxiliary rotary piston divides a space between the working rotary piston and the housing into a working chamber with increasing volume and a working chamber with decreasing volume;
e. the auxiliary rotary piston cooperates with the working rotary piston such that the auxiliary rotary piston expels a working gas from at least one of the working chambers;
f. the auxiliary rotary piston comprises at least one reception portion for receiving therein a separating section of the working rotary piston;
g. the auxiliary rotary piston is force-coupled to the working rotary piston via a gear mechanism;
h. the auxiliary rotary piston is configured asymmetrically;
i. the auxiliary rotary piston comprises elements for stiffening and/or elements for controlling thermal expansion and/or elements for balancing;
j. the auxiliary rotary piston has an eccentric center of gravity;
k. the auxiliary rotary piston is sealed off from the housing;
l. the auxiliary rotary piston rotates with a circumferential speed which is different from that of the working rotary piston; and
m. The axes the axes of the auxiliary rotary pistons and the axis of the working rotary piston are located in the same plane.

5. The rotary piston engine according to claim 1, wherein the duct fulfills at least one of the following requirements:
a. the duct is adapted to be closed;
b. the duct allows a flow of working gas in only one direction;
c. the duct is substantially gas-tight so that the working gas is conducted between an inlet-side and an outlet-side opening of the duct substantially without any pressure losses;
d. the duct is adapted to be closed on the inlet and/or outlet side thereof such that the duct can communicate with only one of the working chambers and/or a working gas is trapped in the duct;
e. the duct can, on the inlet side and/or outlet side thereof, communicate with at least one of the working chambers only in a rotation angle range of the working rotary piston, wherein the rotation angle range of the working rotary piston, in which the duct communicates with at least one of the working chambers on its inlet side, is different from a rotation angle range of the working rotary piston, in which the duct communicates with at least one other of the working chambers on its outlets side;
f. the duct can, on its inlet side, only open towards one of the working chambers and, on its outlet side, only open towards at least one other of the working chambers, so that a working gas can flow into the duct only from at least one of the working chambers; and flow out of the duct only into at least one other of the working chambers;
g. the duct reduces the length of a working gas path, a path through the duct between an inlet-side and an outlet-side opening of the duct being shorter than an arc length about the axis of the working rotary piston between the inlet-side and the outlet-side opening of the duct;
h. the duct comprises at least two duct portions, which are adapted to be aligned with one another so as to allow communication therebetween, at least one of the duct portions rotating within the housing and at least one other of the duct portions belonging to the housing or being fixed in position relative to the housing, wherein at least one of the rotating duct portions and at least one of the stationary duct portions are capable of communicating with one another in a rotation angle range of the working rotary piston, wherein at least one of the rotating duct portions is arranged radially within one of the stationary duct portions and/or at least one of the rotating duct portions is arranged radially outside of at least one of the stationary duct portions;
i. the duct comprises at least two groups of duct portions, wherein the duct portions of one group are adapted to be aligned with one another so as to allow communication therebetween, wherein at least one of the duct portions of a group rotates within the housing and at least one other of the duct portions of a group belongs to the housing or is fixed in position relative to the housing, wherein at least one of the rotating duct portions and at least one of the stationary duct portions of a group are capable of communicating with one another in a rotation angle range of the working rotary piston, wherein, in relation to the axis of the working rotary piston, the duct portions of different groups do not overlap one another in an axial direction and/or not in a radial direction and/or not in a circumferential direction, wherein the duct portions of one group and the duct portions of another group are capable of communicating with one another only in different rotation angle ranges of the working rotary piston, wherein at least one of the rotating duct portions of a group is arranged radially inside of at least one of the stationary duct portions of a group and/or at least one of the rotating duct portions of a group is arranged radially outside of at least one of the stationary duct portions of a group;
j. the duct opens on its inlet side and/or outlet side substantially tangentially to the circumference of the working rotary piston into at least one of the working chambers, an angle defined by an axis of the duct and the tangent on the circumference of the working rotary piston in the area of the opening being not larger than 89° measured in or opposite to the direction of rotation of the working rotary piston;
k. the duct opens on its inlet side and/or outlet side in an axial and/or radial direction, in a radial direction from inside, into at least one of the working chambers;
l. the duct branches, on its inlet side, off from a trailing end of at least one of the working chambers;
m. the duct opens, on its outlet side, into at least one of the working chambers at a leading end;
n. the duct extends, at least sectionwise, within the working rotary piston along and/or within a circumferential surface and/or along or within at least one side part of the working rotary piston;
o. a cross-section of the duct converges on the inlet side and/or diverges on the outlet side;
p. an outlet-side opening of the duct extends over at least 50% of the axial length and/or the circumferential length of the working chamber communicating therewith;
q. an inlet-side opening of the duct and an outlet-side opening of the duct do not overlap in an axial direction and/or not in a radial direction and/or not in a circumferential direction related to the axis of the working rotary piston;
r. an inlet-side opening of the duct and an outlet-side opening of the duct are spaced apart in an axial direction and/or in a radial direction and/or in a circumferential direction related to the axis of the working rotary piston;
s. an inlet-side opening of the duct; and an outlet-side opening of the duct are different in size, the outlet-side opening of the duct being larger than the inlet-side opening of the duct; and
t. at least one second duct transfers a working gas from at least a further one of the working chambers into at least still a further of the working chambers.

6. The rotary piston engine according to claim 1, wherein the rotary piston engine comprises at least one ignition chamber, which fulfills at least one of the following requirements:
a. the duct conducts a working gas through the ignition chamber;
b. the ignition chamber communicates with the duct;
c. the ignition chamber is arranged radially within and/or axially within the working rotary piston;
d. the ignition chamber is formed radially within and/or axially within the working rotary piston;
e. the ignition chamber is located, at least at the moment of ignition, at least partially between the axis of the working rotary piston and the axis of at least one of the auxiliary rotary pistons;
f. the ignition chamber overlaps at least one of the working chambers in a radial direction;
g. the ignition chamber can communicate via at least one opening with an injection device and/or an ignition device, the opening being adapted to be closed, wherein a plurality of ignition devices are arranged on different sides of the ignition chamber;
h. the ignition chamber comprises a cooling and/or an oil lubrication;
i. the ignition chamber is configured as a recess or pocket of the working rotary piston;
j. the ignition chamber rotates together with the working rotary piston;
k. the working rotary piston rotates about the ignition chamber;
l. the ignition chamber is fixed in position relative to the housing;
m. the ignition chamber comprises and/or defines a portion of the duct;
n. the ignition chamber is located on an outlet-side end of the duct;
o. the ignition chamber forms an outlet-side end of the duct; and
p. the ignition chamber opens divergently towards at least one of the working chambers.

7. The rotary piston engine according to claim 1, wherein the rotary piston engine comprises at least one gas passage unit, which fulfills at least one of the following requirements:
a. the duct conducts a working gas through the gas passage unit;
b. the gas passage unit communicates with the duct;
c. the gas passage unit forms a part of the housing;
d. the gas passage unit is fixed in position on the housing from inside or from outside;
e. the gas passage unit is adjustably fixed on the housing;
f. the gas passage unit is mechanically adjustable or dynamically displaceable by an open-loop control or a closed-loop control;
g. the gas passage unit is adapted to be rotated relative to the housing in a circumferential direction;
h. the gas passage unit is arranged coaxially with the working rotary piston;
i. the gas passage unit is substantially hollow cylindrical;
j. the gas passage unit is arranged radially and/or axially within the working rotary piston;
k. the gas passage unit delimits at least one of the working chambers in a radial direction on at least one side;
l. the gas passage unit delimits the ignition chamber in a radial direction on at least on one side;
m. the gas passage unit comprises the ignition chamber;
n. the gas passage unit can be sealingly installed in a reception means of the working rotary piston, so that the gas passage unit and a radially outer section of the working rotary piston define together at least one of the working chambers and/or the gas passage unit and a radially inner section of the working rotary piston define together at least one ignition chamber;
o. the gas passage unit comprises at least one portion of the duct adapted to be aligned with at least one other portion of the duct such that the duct portions can communicate in an axial and/or radial direction in relation to the axis of the working rotary piston;
p. the gas passage unit comprises at least two portions of the duct, which are each adapted to be alternately aligned with at least one other portion of the duct such that the duct portions can communicate in an axial and/or radial direction in relation to the axis of the working rotary piston;
q. the gas passage unit comprises at least two gas passage portions, which are displaceable relative to one another and which each comprise at least one portion of the duct, the gas passage portions being displaceable while the portions of the duct communicate with one another, the gas passage portions being rotatable relative to one another;
r. the gas passage unit comprises at least one post-compressor; and
s. at least one of the duct portions of the gas passage unit is substantially slot-shaped and extends in a circumferential direction through a circumferential surface of the gas passage unit.

8. The rotary piston engine according to claim 1, wherein at least one of the working chambers fulfills at least one of the following requirements:
a. at least one of the working chambers forms a compression chamber for compressing a working gas;
b. at least one of the working chambers forms an expansion chamber for expanding a working gas;
c. at least two of the working chambers have, in relation to a rotation axis of the working rotary piston, different axial and/or radial dimensions;
d. at least two of the working chambers have, in a plane including a rotation axis of the working rotary piston, different cross-sectional shapes;
e. in a plane including a rotation axis of the working rotary piston, a working chamber or a group of working chambers having the larger cross-sectional area forms a compression chamber or a group of compression chambers, and a working chamber or a group of working chambers having the smaller cross-sectional shape forms an expansion chamber or a group of expansion chambers;
f. at least two of the working chambers are displaced relative to one another in an axial direction and/or in a radial direction and/or in a circumferential direction;
g. at least two of the working chambers are arranged in succession in a direction of circulation;
h. at least two of the working chambers are arranged in an overlapping mode of arrangement in an axial direction and/or in a radial direction and/or in a circumferential direction;
i. at least two of the working chambers are arranged in a non-overlapping mode of arrangement in an axial direction and/or in a radial direction and/or in a circumferential direction; and
j. at least two of the working chambers are arranged, at least sectionwise, side-by-side in an axial direction.

9. The rotary piston engine according to claim 1, wherein the rotary piston engine comprises at least one post-compressor, which fulfills at least one of the following requirements:
a. the duct conducts a working gas through the post-compressor so that the working gas is compressed in the post-compressor;
b. the post-compressor communicates with the duct;
c. the post-compressor compresses a working gas after the working gas has left at least one of the working chambers;
d. the post-compressor compresses the working gas before the working gas is introduced in another one of the working chambers;
e. the post-compressor compresses the working gas mechanically and/or pneumatically and/or hydraulically;
f. the post-compressor expels the working gas completely in the direction of an outlet-side working chamber;
g. the post-compressor supports the introduction of the working gas into an inlet-side working chamber by aspirating the working gas while the post-compressor communicates with the inlet-side working chamber via the duct;
h. the post-compressor causes self-ignition of the working gas through compression;
i. the post-compressor comprises a reciprocating piston compressor with at least one reciprocating piston and at least one compression chamber, wherein the reciprocating piston compressor forms two compression chambers at opposed end of the reciprocating piston, wherein the reciprocating piston temporarily closes and temporarily opens at least one inlet-side and/or at least one outlet-side opening of the compression chamber 70;
j. the post-compressor comprises at least one cam for moving at least one reciprocating piston of a reciprocating piston compressor, wherein the cam is preferably is mechanically coupled to the working rotary piston and/or arranged coaxially with the working rotary piston, wherein the cam rotates with the same angular speed as the working rotary piston;
k. the post-compressor is arranged, at least sectionwise, radially within and/or axially within the working rotary piston;
l. the post-compressor forms, at least sectionwise, the ignition chamber; and
m. the working gas is ignited within the post-compressor.

10. A method of operating a rotary piston engine according to claim 1, wherein the method comprising the following steps:
a. compressing a working gas in at least one of the working chambers;
b. introducing the compressed working gas into the duct; and
c. discharging the working gas for expansion into at least one other of the working chambers.
